(19) United States
(12) Patent Application Publication
(10) Pub. No.: US 2008/0240615 A1
(43) Pub. Date: Oct. 2, 2008

(54) Image processing for image deformation

(75) Inventor: Akio Yamazaki, Shiojiri-shi (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/079,568

(22) Filed: Mar. 27, 2008

(30) Foreign Application Priority Data
Mar. 27, 2007 (JP) 2007-082311

(51) Int. Cl. G06K 9/36

(52) U.S. Cl. 382/287

(57) ABSTRACT

An image processing device, which performs deformation of an image, includes a deformation area setting unit, a deformation area dividing unit, and a deformation processing unit. The deformation area setting unit sets at least a portion of an area on a target image as a deformation area. The deformation area dividing unit divides the deformation area into a plurality of small areas. The deformation processing unit performs deformation of an image within the deformation area by deforming the small areas. The deformation processing unit performs deformation of an image in such a manner that, with respect to a small area having a N-polygonal shape among the plurality of small areas, N triangles that are defined by line segments, each of which connects the center of gravity of the small area, which has not yet been deformed, with each vertex of the same small area, are deformed into N triangles that are defined by line segments, each of which connects the center of gravity of the small area, which has been deformed, with each vertex of the same small area.

### BACKGROUND

Priority is claimed under 35 U.S.C. § 119 to Japanese Patent Application No. 2007-082311 filed on Mar. 12, 2007, which is hereby incorporated by reference in its entirety.

1. Technical Field

The present invention relates to an image processing technology for deforming an image.

2. Related Art

An image processing technology by which a digital image is deformed has been known, which is, for example, described in JP-A-2004-318204. JP-A-2004-318204 describes an image processing in which the shape of a face is deformed in such a manner that a portion of the area on the image of a face (e.g., area that shows the image of a cheek) is set as a correction area, the correction area is divided into a plurality of small areas in accordance with a predetermined pattern and then the image is enlarged or reduced by a scaling factor set for each small area.

In the above existing image processing for image deformation, in regard to each of the plurality of small areas, enlargement or reduction of an image is performed by a scaling factor set for each small area, so that the processing has been complicated. In particular, in accordance with the processing, it requires many pieces of information, such as information regarding a method of dividing the area into small areas. This makes it difficult to attempt to effectively perform the processing.

### SUMMARY

An advantage of some aspects of at least one embodiment of the invention is that it provides a technology for making it possible to effectively perform image processing for image deformation.

An aspect of at least one embodiment of the invention provides an image processing device that performs deformation of an image. The image processing device includes a deformation area setting unit, a deformation area dividing unit, and a deformation processing unit. The deformation area setting unit sets at least a portion of the area on a target image as a deformation area. The deformation area dividing unit divides the deformation area into a plurality of small areas. The deformation processing unit performs deformation of an image within the deformation area by deforming the small areas. The deformation processing unit performs deformation of an image in such a manner that, with respect to a small area having a N-polygonal shape among the plurality of small areas, N triangles that are defined by line segments, each of which connects the center of gravity of the small area, which has not yet been deformed, with each vertex of the same small area, are deformed into N triangles that are defined by line segment, each of which connects the center of gravity of the small area, which has been deformed, with each vertex of the same small area.

In this image processing device, the deformation area is divided into a plurality of small areas, and each of the small areas is deformed, so that the deformation of an image in the deformation area is performed. At this time, in each of the N-polygonal small areas that have not yet been deformed, N triangles are defined by line segments, each of which connects the center of gravity of the small area with each vertex of the same small area. Similarly, in each of the N-polygonal small areas that have been deformed as well, N triangles are defined by line segments, each of which connects the center of gravity of the small area with each vertex of the same small area. Then, the deformation of the image is performed on a triangle area basis. Here, the position of the center of gravity of each small area may be calculated from the coordinates of four vertexes. Therefore, it is possible to reduce the number of coordinates required to be specified in deformation processing. Thus, in this image processing device, it is possible to effectively perform image processing for image deformation.

In the above image processing device, the deformation area setting unit may set the deformation area so that the deformation area includes at least a portion of the image of a face.

According to the above configuration, it is possible to effectively perform image processing for image deformation intended for the image of a face.

In addition, the above image processing device may further include a face area detection unit that detects a face area in which the image of the face appears on the target image, wherein the deformation area setting unit may set the deformation area on the basis of the detected face area.

According to the above configuration, it is possible to effectively perform image processing for image deformation of the deformation area that is set on the basis of the face area detected from the target image.

In addition, the above image processing device may further include a printing unit that prints out the target image on which deformation of an image in the deformation area has been performed.

According to the above configuration, it is possible to effectively perform image processing for image deformation when the image is deformed and then printed.

Note that the aspects of the invention may be implemented in various forms. For example, it may be implemented in a form, such as an image processing method and device, an image deformation method and device, an image correction method and device, a computer program for implementing the functions of these methods or devices, a recording medium that contains the computer program, data signals that are realized in carrier waves that contain the computer program, and the like.

### BRIEF DESCRIPTION OF THE DRAWINGS

The invention will be described with reference to the accompanying drawings, wherein like numbers reference like elements.

FIG. 1 is a view that schematically illustrates the configuration of a printer, which serves as an image processing device, according to a first example embodiment of the invention.

FIG. 2 is a view that illustrates one example of a user interface that includes the list display of images.

FIG. 3 is a flowchart that shows the flow of a face shape correction printing process that is performed by the printer according to the present example embodiment.

FIG. 4 is a flowchart that shows the flow of a face shape correction process according to the present example embodiment.

FIG. 5 is a view that illustrates one example of a user interface for setting the type and degree of image deformation.

FIG. 6 is a view that illustrates one example of the detection result of a face area.

FIG. 7 is a flowchart that shows the flow of a position adjustment process in which the position of the face area in the height direction is adjusted according to the present example embodiment.

FIG. 8 is a view that illustrates one example of a specific area.

FIG. 9 is a view that illustrates one example of a method of calculating evaluation values.

FIG. 10A and FIG. 10B are views, each of which illustrates one example of a method of selecting evaluation target pixels.

FIG. 11 is a view that illustrates one example of a method of determining a height reference point.

FIG. 12 is a view that illustrates one example of a method of calculating an approximate inclination angle.

FIG. 13 is a view that illustrates one example of a method of adjusting the position of the face area in the height direction.

FIG. 14 is a flowchart that shows the flow of an inclination adjustment process in which an inclination of the face area is adjusted according to the present example embodiment.

FIG. 15 is a view that illustrates one example of a method of calculating evaluation values used for adjusting an inclination of the face area.

FIG. 16 is a view that illustrates one example of the calculation result of variance of evaluation values with respect to each evaluation direction.

FIG. 17 is a view that illustrates one example of a method of adjusting an inclination of the face area.

FIG. 18 is a view that illustrates one example of a method of setting a deformation area.

FIG. 19 is a view that illustrates one example of a method of dividing the deformation area into small areas.

FIG. 20 is a view that illustrates one example of the contents of a dividing point moving table.

FIG. 21 is a view that illustrates one example of movement of positions of dividing points in accordance with the dividing point moving table.

FIG. 22 is a view that illustrates the concept of a deformation processing method of an image using a deformation processing unit.

FIG. 23 is a view that illustrates the concept of a method of processing the deformation of an image in a triangle area.

FIG. 24 is a view that illustrates one mode of face shape correction according to the present example embodiment.

FIG. 25 is a view that illustrates one example of the state of a display unit on which a target image obtained after face shape correction is displayed.

FIG. 26 is a flowchart that shows the flow of a corrected image printing process according to the present example embodiment.

FIG. 27 is a view that illustrates another example of the contents of the dividing point moving table.

FIG. 28 is a view that illustrates another example of a method of arranging dividing points.

FIG. 29 is a view that illustrates yet another example of the contents of the dividing point moving table.

FIG. 30 is a view that illustrates one example of a user interface by which a user specifies a moving mode of dividing points.

### DESCRIPTION OF EXEMPLARY EMBODIMENTS

Hereinafter, an embodiment of the invention will be described in the following order on the basis of an example embodiment.

### A. First Example Embodiment

### A-1. Configuration of Image Processing Device

### A-2. Face Shape Correction Printing Process

### A-3. Alternative Embodiment of First Example Embodiment

### B. Other Alternative Embodiments

### A. First Example Embodiment

### A-1. Configuration of Image Processing Device

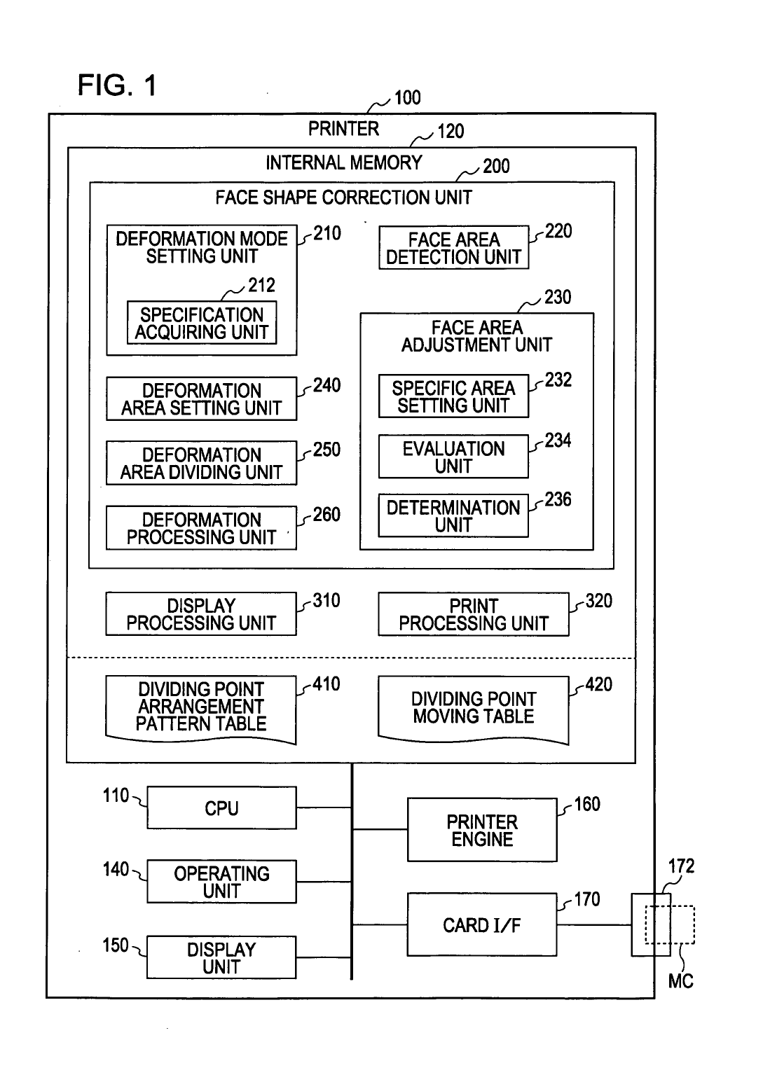

FIG. 1 is a view that schematically illustrates the configuration of a printer 100, which serves as an image processing device, according to a first example embodiment of the invention. The printer 100 of the present example embodiment is a color ink jet printer that is able to print out an image on the basis of image data acquired from a memory card MC, or the like, which is so-called direct print. The printer 100 includes a CPU 110, an internal memory 120, an operating unit 140, a display unit 150, a printer engine 160, and a card interface (card I/F) 170. The CPU 110 controls portions of the printer 100. The internal memory 120 is, for example, formed of ROM and/or RAM. The operating unit 140 is formed of buttons and/or a touch panel. The display unit 150 is formed of a liquid crystal display. The printer 100 may further include an interface that performs data communication with other devices (for example, a digital still camera). The components of the printer 100 are connected through a bus with one another.

The printer engine 160 is a printing mechanism that performs printing on the basis of print data. The card interface 170 is an interface that transmits or receives data to or from the memory card MC that is inserted in a card slot 172. Note that, in the present example embodiment, the memory card MC contains image data as RGB data, and the printer 100 acquires the image data stored in the memory card MC through the card interface 170.

The internal memory 120 contains a face shape correction unit 200, a display processing unit 310 and a print processing unit 320. The face shape correction unit 200 is a computer program that executes face shape correction process, which will be described later, under a predetermined operating system. The display processing unit 310 is a display driver that controls the display unit 150 to display a processing menu or a message on the display unit 150. The print processing unit 320 is a computer program that generates print data using image data, controls the printer engine 160 and then executes printing of an image on the basis of the print data. The CPU 110 reads out these programs from the internal memory 120 and then executes the programs to thereby realize the functions of these units.

The face shape correction unit 200 includes, as a program module, a deformation mode setting unit 210, a face area detection unit 220, a face area adjustment unit 230, a deformation area setting unit 240, a deformation area dividing unit 250 and a deformation processing unit 260. The deformation mode setting unit 210 includes a specification acquiring unit 212, and the face area adjustment unit 230 includes a specific area setting unit 232, an evaluation unit 234 and a determination unit 236. The functions of these units will be specifically described in the description of the face shape correction printing process, which will be described later.

The internal memory 120 also contains a dividing point arrangement pattern table 410 and a dividing point moving table 420. The contents of the dividing point arrangement pattern table 410 and dividing point moving table 420 also will be specifically described in the description of the face shape correction printing process, which will be described later.

### A-2. Face Shape Correction Printing Process

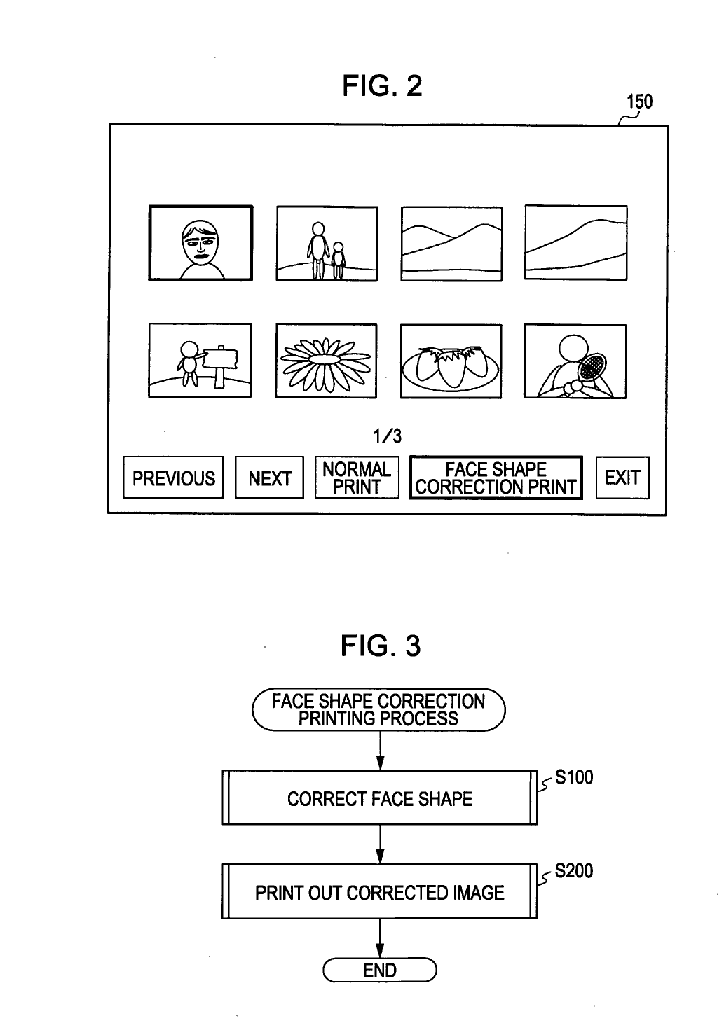

The printer 100 prints out an image on the basis of image data stored in the memory card MC. As the memory card MC is inserted into the card slot 172, a user interface that includes the list display of images stored in the memory card MC is displayed on the display unit 150 by the display processing unit 310. FIG. 2 is a view that illustrates one example of a user interface that includes the list display of images. Note that, in the present example embodiment, the list display of images is performed using thumbnail images included in the image data (image file) that are stored in the memory card MC.

The printer 100 of the present example embodiment, when a user selects an image (or multiple images) and in addition selects a normal print button using the user interface shown in FIG. 2, executes a normal printing process in which the printer 100 prints out the selected image as usual. On the other hand, when a user selects an image (or multiple images), and in addition selects a face shape correction print button using the user interface, the printer 100 executes a face shape correction printing process on the selected image, in which the v printer 100 corrects the shape of a face in the image and then prints out the corrected image.

FIG. 3 is a flowchart that shows the flow of a face shape correction printing process performed by the printer 100 according to the present example embodiment. In step S100, the face shape correction unit 200 (FIG. 1) executes a face shape correction process. The face shape correction process of the present example embodiment is a process in which at least part of the shape of a face (for example, the shape of the contour of a face and the shape of eyes) in the image is corrected.

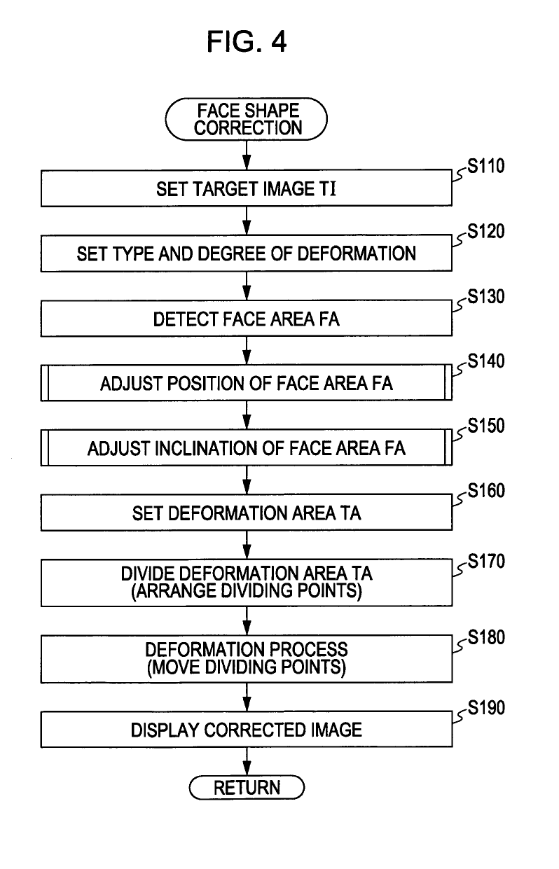

FIG. 4 is a flowchart that shows the flow of the face shape correction process according to the present example embodiment. In step S110, the face shape correction unit 200 (FIG. 1) sets a target image TI on which the face shape correction process is executed. The face shape correction unit 200 sets the image, which is selected by a user using the user interface shown in FIG. 2, as the target image TI. The image data of the set target image TI are acquired by the printer 100 from the memory card MC through the card interface 170 and are stored in a predetermined area of the internal memory 120.

In step S120 (FIG. 4), the deformation mode setting unit 210 (FIG. 1) sets the type of image deformation and the degree of image deformation for face shape correction. The deformation mode setting unit 210 instructs the display processing unit 310 to display a user interface, with which the type and degree of image deformation are set, on the display unit 150, selects the type and degree of image deformation that are specified by the user through the user interface, and then sets the type and degree of image deformation used for processing.

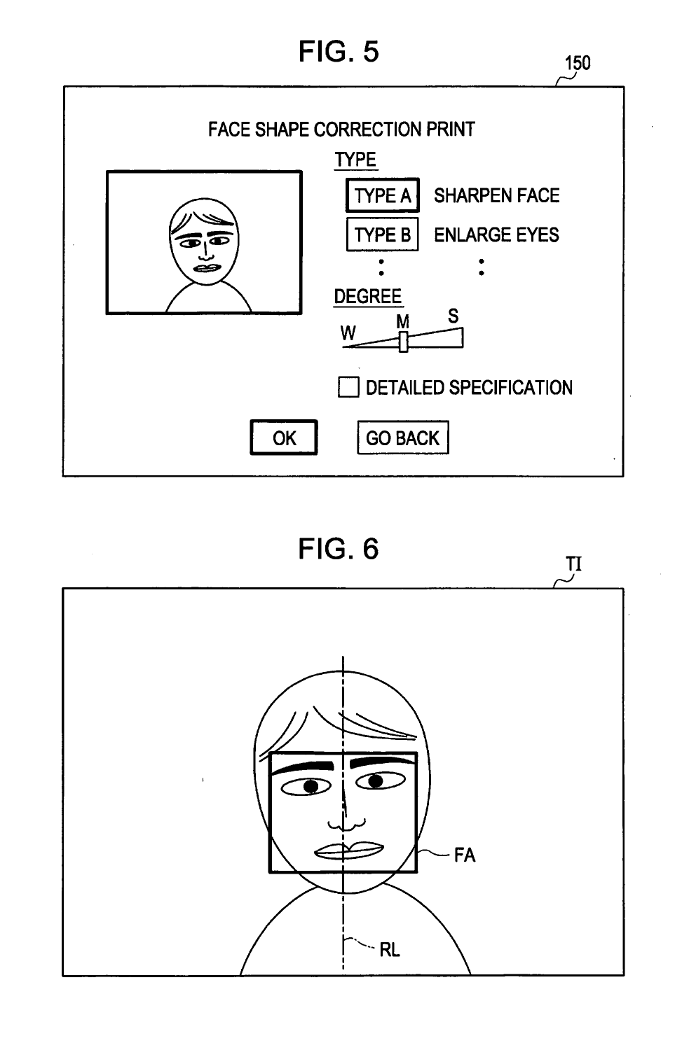

FIG. 5 is a view that illustrates one example of a user interface for setting the type and degree of image deformation. As shown in FIG. 5, this user interface includes an interface for setting the type of image deformation. In the present example embodiment, for example, a deformation type “type A” in which the shape of a face is sharpened, a deformation type “type B” in which the shape of eyes is enlarged, and the like, are set in advance as choices. The user specifies the type of image deformation using this interface. The deformation mode setting unit 210 sets the image deformation type, which is specified by the user, as an image deformation type used for actual processing.

In addition, the user interface shown in FIG. 5 includes an interface for setting the degree (extent) of image deformation. As shown in FIG. 5, in the present example embodiment, the degree of image deformation is set in advance as choices of three steps Strong (S), Middle (M) and Weak (W). The user specifies the degree of image deformation using this interface. The deformation mode setting unit 210 sets the degree of image deformation, which is specified by the user, as the degree of image deformation used for actual processing.

Note that, in the present example embodiment, a detailed specification of deformation mode can be set by a user, as will be described later. In the user interface shown in FIG. 5, when the user checks the checkbox that indicates that a detailed specification is desired, a detailed specification of deformation mode is performed by the user, as will be described later.

In the following description, it is assumed that the deformation type “type A” in which the shape of a face is sharpened is set as the type of image deformation, the degree of extent “Middle” is set as the degree of image deformation, and a detailed specification is not desired by the user.

In step S130 (FIG. 4), the face area detection unit 220 (FIG. 1) detects a face area FA in the target image TI. Here, the face area FA means an image area on the target image TI and an area that includes at least part of image of a face. The detection of the face area FA by the face area detection unit 220 is executed by means of a known face detection method, such as a method through pattern matching using, for example, templates (refer to JP-A-2004-318204).

FIG. 6 is a view that illustrates one example of the detection result of the face area FA. As shown in FIG. 6, according to the face detection method used in the present example embodiment, a rectangular area that includes the images of eyes, a nose and a mouth on the target image TI is detected as the face area FA. Note that the reference line RL shown in FIG. 6 defines a height direction (up and down direction) of the face area FA and is a line that indicates the center in the width direction (right to left direction) of the face area FA. That is, the reference line RL is a straight line that passes the center of gravity of the rectangular face area FA and is parallel to the boundary lines that extend along the height direction (up and down direction) of the face area FA.

Note that, in the detection of the face area FA in step S130, when the face area FA is not detected, the user is notified to that effect through the display unit 150. In this case, normal printing that does not accompany face shape correction may be performed or a detection process to detect the face area FA may be performed again using another face detection method.

Here, generally, the known face detection method, such as a method through pattern matching using templates, does not minutely detect the position or inclination (angle) of the entire face or portions of a face (eyes, a mouth, or the like) but sets an area in the target image TI, in which it may be regarded that the image of a face is substantially included, as the face area FA. On the other hand, the printer 100 of the present example embodiment sets an area (deformation area TA, which will be described later) on which an image deformation process for face shape correction is performed on the basis of the detected face area FA, as will be described later. Because generally the image of a face highly attracts viewer's attention, there is a possibility that an image on which face shape correction has been performed may be unnatural depending on the relationship in position and/or angle between the set deformation area TA and the image of a face. Then, in the present example embodiment, in order to achieve more natural and desirable face shape correction, position adjustment and inclination adjustment described below are performed on the face area FA that has been detected in step S130.

In step S140 (FIG. 4), the face area adjustment unit 230 (FIG. 1) adjusts the position, in the height direction, of the face area FA that has been detected in step S130. Here, the adjustment of position of the face area FA in the height direction means resetting the face area FA in the target image TI by adjusting the position, along the reference line RL, of the face area FA (see FIG. 6).

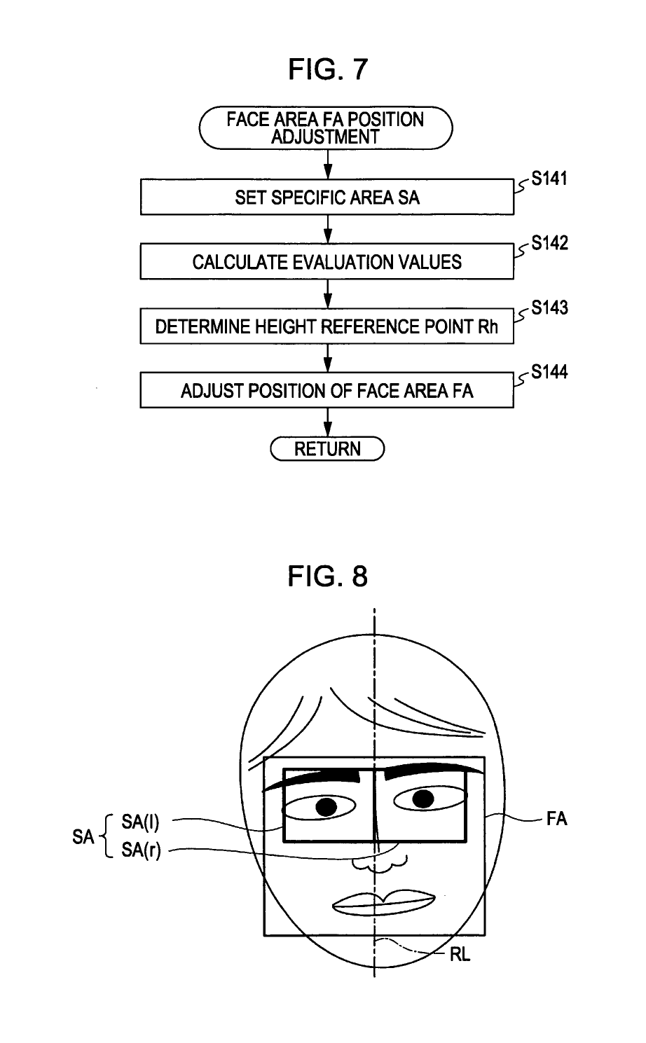

FIG. 7 is a flowchart that shows the flow of a position adjustment process in which the position of the face area FA in the height direction is adjusted according to the present example embodiment. In step S141, the specific area setting unit 232 (FIG. 1) sets a specific area SA. Here, the specific area SA is an area on the target image TI and is an area that includes an image of a predetermined reference subject that is referenced when the adjustment of position of the face area FA in the height direction is executed. In the present example embodiment, the reference subject is set to “eyes”, and the specific area SA is set to an area that includes the image of “eyes”.

FIG. 8 is a view that illustrates one example of the specific area SA. In the present example embodiment, the specific area setting unit 232 sets the specific area SA on the basis of the relationship with the face area FA. Specifically, the specific area SA is set as an area that is obtained by reducing (or enlarging) the size of the face area FA by a predetermined ratio in a direction perpendicular to the reference line RL and in a direction parallel to the reference line RL and that has a predetermined positional relationship with the position of the face area FA. That is, in the present example embodiment, the predetermined ratio and the predetermined positional relationship are determined in advance so that, when the specific area SA is set on the basis of the relationship with the face area FA that is detected by the face area detection unit 220, the specific area SA includes the image of both eyes. Note that the specific area SA is desirably set as an area as small as possible in so far as the area includes the image of both eyes so as not to include a confusing image (for example, the image of hair) with the image of eyes as much as possible.

In addition, as shown in FIG. 8, the specific area SA is set to an area having a rectangular shape that is symmetrical with respect to the reference line RL. The specific area SA is divided by the reference line RL into a left side area (hereinafter, also referred to as “left divided specific area SA(1)”) and a right side area (hereinafter, also referred to as “right divided specific area SA(r)”). The specific area SA is set so that one of the eyes is included in each of the left divided specific area SA(1) and the right divided specific area SA(r).

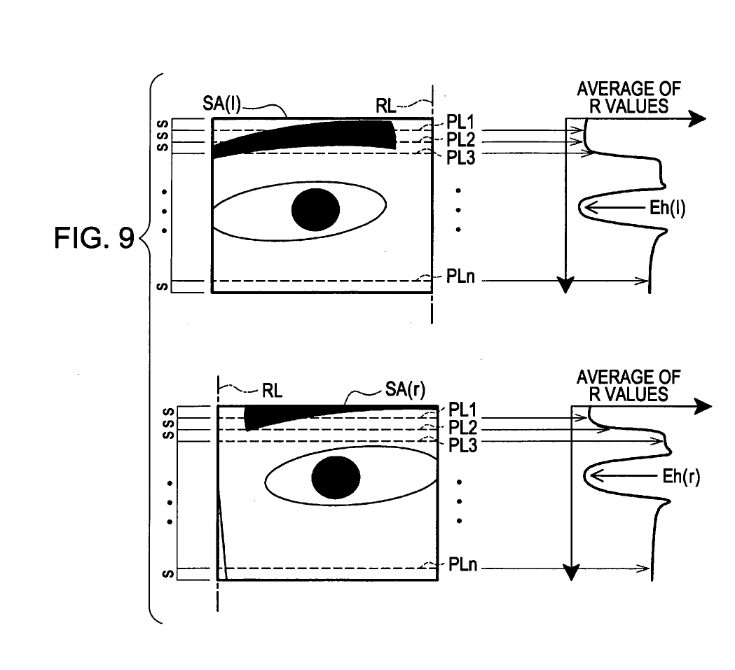

In step S142 (FIG. 7), the evaluation unit 234 (FIG. 1) calculates evaluation values for detecting the position of the image of an eye in the specific area SA. FIG. 9 is a view that illustrates one example of a method of calculating the evaluation values. In the present example embodiment, R values (R component values) of pixels of the target image TI, which are RGB image data, are used for calculation of the evaluation values. This is because there is a large difference in R values between the image of portion of a skin and the image of portion of an eye and, therefore, it may be presumed that it is possible to improve the detection accuracy of the image of an eye using R values for calculation of evaluation values. In addition, in the present example embodiment, because the data of the target image TI are acquired as RGB data, it is possible to attempt to effectively calculate evaluation values using R values for calculation of the evaluation values. Note that, as shown in FIG. 9, calculation of evaluation values is separately performed for two divided specific areas (the right divided specific area SA(r) and the left divided specific area SA(1)).

The evaluation unit 234, as shown in FIG. 9, sets n straight lines (hereinafter, referred to as “target pixel specifying lines PL1 to PLn”) perpendicular to the reference line RL within each of the divided specific areas (the right divided specific area SA(r) and the left divided specific area SA(1)). The target pixel specifying lines PL1 to PLn are straight lines that equally divide the height (the size along the reference line RL) of each of the divided specific areas into (n+1) parts. That is, the interval between any adjacent target pixel specifying lines PL is an equal interval s.

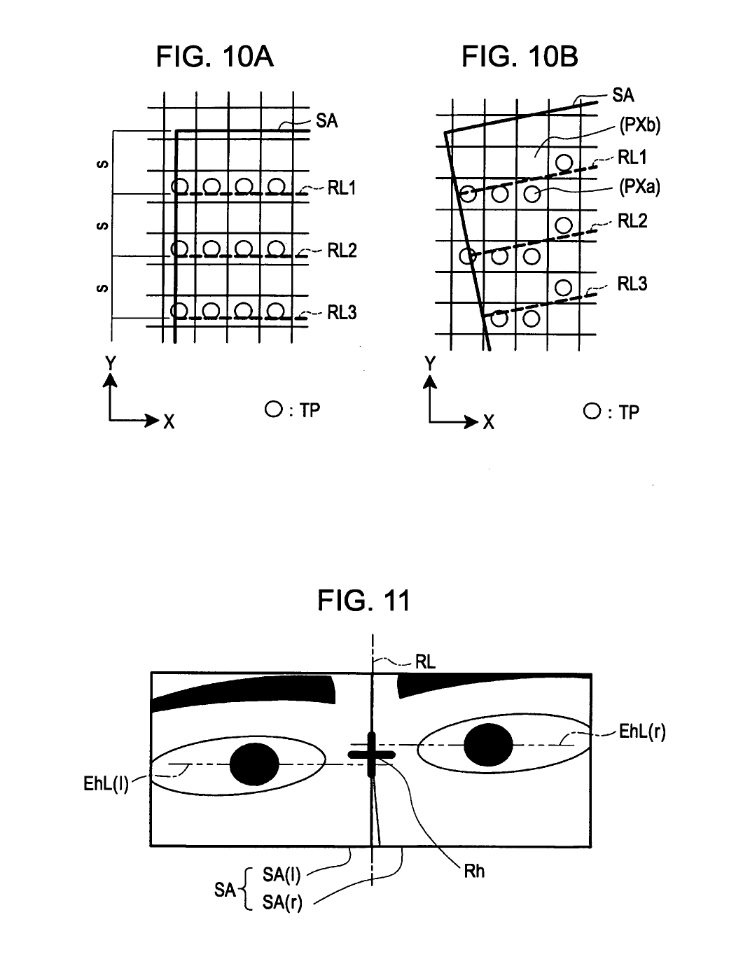

The evaluation unit 234 selects pixels (hereinafter, referred to as “evaluation target pixels TP”) used for calculation of evaluation values from among pixels that constitute the target image TI for each of the target pixel specifying lines PL1 to PLn. FIG. 10A and FIG. 10B are views, each of which illustrates one example of a method of selecting evaluation target pixels TP. The evaluation unit 234 selects pixels that overlap the target pixel specifying lines PL from among the pixels that constitute the target image TI as the evaluation target pixels TP. FIG. 10A shows the case where the target pixel specifying lines PL are parallel to the row direction (X direction in FIG. 10A) of the pixels of the target image TI. In this case, the pixels arranged in each pixel row that overlap each of the target pixel specifying lines PL (pixels to which symbol “O” is assigned in FIG. 10A) are selected as the evaluation target pixels TP with respect to each of the target pixel specifying lines PL.

On the other hand, depending on a method of detecting the face area FA or a method of setting the specific area SA, the target pixel specifying lines PL may possibly be not parallel to the row direction (X direction) of the pixels of the target image TI, as shown in FIG. 10B. In such a case as well, as a rule, the pixels that overlap each of the target pixel specifying lines PL are selected as the evaluation target pixels TP with respect to each of the target pixel specifying lines PL. However, for example, as in the case of the relationship between the target pixel specifying line PL1 and pixels PXa and PXb, shown in FIG. 10B, when one target pixel specifying line PL overlaps two pixels arranged in the same column (that is, having the same Y coordinate) of the pixel matrix of the target image TI, one of the pixels (for example, the pixel PXb) that overlaps the target pixel specifying line PL shorter in distance than the other is excluded from the evaluation target pixel TP. That is, for each of the target pixel specifying lines PL, only one pixel is selected from one column of the pixel matrix as the evaluation target pixel TP.

Note that, when the inclination of the target pixel specifying line PL exceeds 45 degrees with respect to the X direction, the relationship between the column and row of the pixel matrix in the above description is inverted and, therefore, only one pixel is selected from one row of the pixel matrix as the evaluation target pixel TP. In addition, depending on the relationship in size between the target image TI and the specific area SA, one pixel may be selected as the evaluation target pixel TP with respect to a plurality of the target pixel specifying lines PL.

The evaluation unit 234 calculates the average of R values of the evaluation target pixels TP for each of the target pixel specifying lines PL. However, in the present example embodiment, with respect to each of the target pixel specifying lines PL, a portion of pixels each having a large R value within the plurality of selected evaluation target pixels TP are excluded from calculation of evaluation values. Specifically, for example, when k evaluation target pixels TP are selected with respect to one target pixel specifying line PL, the evaluation target pixels TP are separated into two groups, that is, a first group, which is composed of 0.75 k pixels each having a relatively large R value, and a second group, which is composed of 0.25 k pixels each having a relatively small R values, and then only the pixels that belong to the second group are used to calculate the average of R values as an evaluation value. The reason why a portion of evaluation target pixels TP are excluded from calculation of evaluation values will be described later.

As described above, in the present example embodiment, the evaluation value with respect to each of the target pixel specifying lines PL is calculated by the evaluation unit 234. Here, because the target pixel specifying lines PL are straight lines that are perpendicular to the reference line RL, the evaluation values may be expressed to be calculated with respect to a plurality of positions (evaluation positions) along the reference line RL. In addition, each of the evaluation values may be expressed as a value that represents the characteristics of distribution of pixel values arranged along a direction perpendicular to the reference line RL with respect to each of the evaluation positions.

In step S143 (FIG. 7), the determination unit 236 (FIG. 1) detects the positions of eyes in the specific area SA and then determines a height reference point Rh on the basis of the detection result. First, with respect to each of the divided specific areas, the determination unit 236, as shown on the right side in FIG. 9, creates a curve that represents a distribution of evaluation values (average of R values) along the reference line RL and then detects a position, at which the evaluation value takes a minimum value along the direction of reference line RL, as an eye position Eh. Note that the eye position Eh in the left divided specific area SA(1) is denoted as Eh(1) and the eye position Eh in the right divided specific area SA(r) is denoted as Eh(r).

In the case of an Asian race, it may be presumed that the portion that displays the image of a skin in the divided specific area has a large R value, while, on the other hand, the portion that displays the image of an eye (more specifically, a black eye portion of the center of each eye) has a small R value. Therefore, as described above, the position, at which the evaluation value (the average of R values) takes a minimum value along the reference line RL, may be determined as the eye position Eh.

Note that, as shown in FIG. 9, the divided specific area may possibly include another image (for example, the image of an eyebrow or the image of hair) having a small R value, in addition to the image of an eye. For this reason, the determination unit 236, when the curve that represents a distribution of evaluation values along the reference line RL takes multiple minimum values, determines the position, which is located on the lowest side within the positions that take minimum values, as the eye position Eh. In general, it is presumed that images, such as an eyebrow or hair, having small R values are mostly located higher than the image of an eye, while, on the other hand, images having small R values are rarely located lower than the image of an eye, so that the above described determination is possible.

In addition, even when the above curve is located lower (mainly, a position corresponding to the image of a skin) than the position of the image of an eye, because there is a possibility that the curve may take a minimum value despite its large evaluation value, minimum values that exceed a predetermined threshold value may be ignored. Alternatively, the position of the target pixel specifying line PL, which corresponds to a minimum value among evaluation values calculated with respect to the target pixel specifying lines PL may be simply determined as the eye position Eh.

Note that, in the present example embodiment, an eye (a black eye portion of the center of each eye), at which it may be presumed that a difference in color from its surrounding is large, is used as a reference subject for adjusting the position of the face area FA. However, because the average value of R values as the evaluation value is calculated for the plurality of evaluation target pixels TP on each of the target pixel specifying lines PL, there is a possibility that the accuracy of detection of a black eye portion may be deteriorated, for example, due to the influence of an image of a white eye portion that surrounds the black eye. In the present example embodiment, as described above, the accuracy of detection of a reference subject is further improved in such a manner that a portion of evaluation target pixels TP (for example, pixels having a relatively large R value, belonging to the above described first group), which may be regarded to have a large color difference in comparison with the reference subject, are excluded from calculation of evaluation values.

Next, the determination unit 236 determines a height reference point Rh on the basis of the detected eye position Eh. FIG. 11 is a view that illustrates one example of a method of determining the height reference point Rh. The height reference point Rh is a point used as a reference when the position of the face area FA in the height direction is adjusted. In the present example embodiment, as shown in FIG. 11, the point that is located at the middle of the positions Eh(1) and Eh(r) of the two right and left eyes on the reference line RL is set as the height reference point Rh. That is, the midpoint of the intersection point of a straight line EhL(1), which indicates the left eye position Eh(1), and the reference line RL and the intersection point of a straight line EhL(r), which indicates the right eye position Eh(r), and the reference line RL is set as the height reference point Rh.

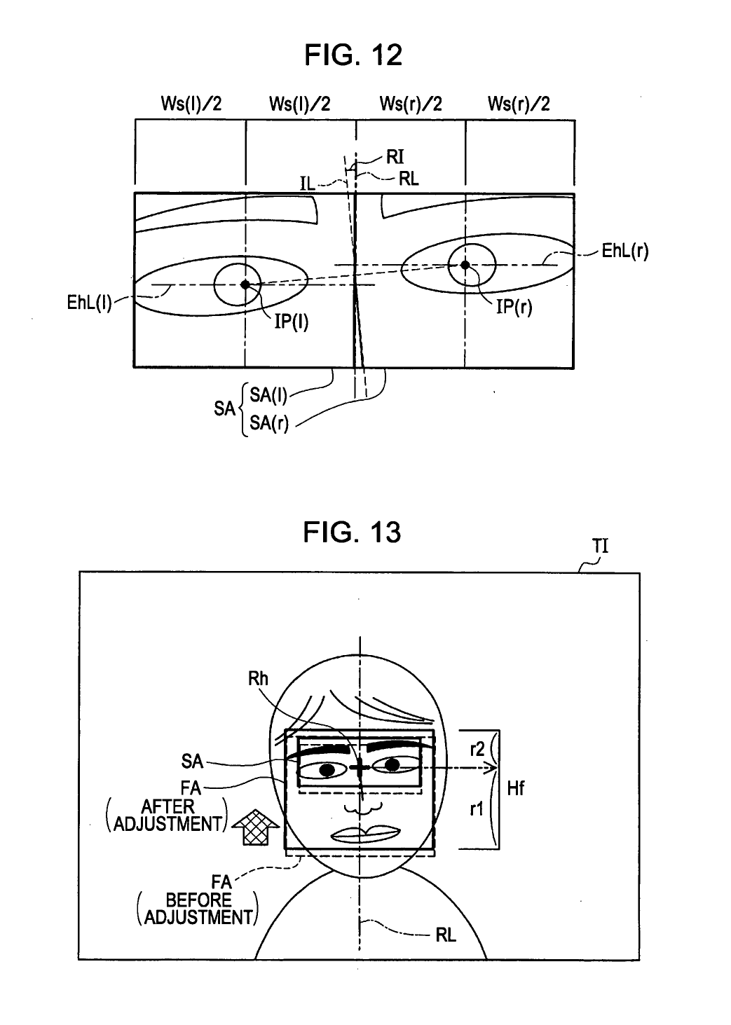

Note that, in the present example embodiment, the determination unit 236 calculates an approximate inclination angle (hereinafter, referred to as “approximate inclination angle RI”) of a face image on the basis of the detected eye position Eh. The approximate inclination angle RI of a face image is an angle that is obtained by estimating how many angles at which the image of a face in the target image TI is approximately inclined with respect to the reference line RL of the face area FA. FIG. 12 is a view that illustrates one example of a method of calculating the approximate inclination angle RI. As shown in FIG. 12, the determination unit 236 first determines an intersection point IP(1) of a straight line, which divides the width Ws(1) of the left divided specific area SA(1) in half, and the straight line EhL(1) and an intersection point IP(r) of a straight line, which divides the width Ws(r) of the right divided specific area SA(r) in half, and the straight line EhL(r). Then, an angle that is made by a straight line IL perpendicular to the straight line that connects the intersection point IP(1) and the intersection point IP(r) with the reference line RL is calculated as the approximate inclination angle RI.

In step S144 (FIG. 7), the face area adjustment unit 230 (FIG. 1) adjusts the position of the face area FA in the height direction. FIG. 13 is a view that illustrates one example of a method of adjusting the position of the face area FA in the height direction. The adjustment of the position of the face area FA in the height direction is performed in such a manner that the face area FA is reset so that the height reference point Rh is located at a predetermined position in the face area FA of which the position has been adjusted. Specifically, as shown in FIG. 13, the position of the face area FA is adjusted upward or downward along the reference line RL so that the height reference point Rh is located at a position at which the height Hf of the face area FA is divided by a predetermined ratio of r1 to r2. In the example shown in FIG. 13, by moving the face area FA, of which the position has not yet been adjusted as shown by the dotted line, upward, the face area FA, of which the position is adjusted as shown by the solid line, is reset.

After the position of the face area FA has been adjusted, in step S150 (FIG. 4), the face area adjustment unit 230 (FIG. 1) adjusts the inclination (adjusts the angle) of the face area FA. Here, the adjustment of inclination of the face area FA means resetting the face area FA so that the inclination of the face area FA in the target image TI is adjusted to conform to the inclination of the image of the face. In the present example embodiment, the predetermined reference subject that is referenced when the adjustment of inclination of the face area FA is executed is set to “both eyes”. In the adjustment of inclination of the face area FA according to the present example embodiment, a plurality of evaluation directions that represent the choices of adjustment angles of inclination are set, and the evaluation specific area ESA corresponding to each of the evaluation directions is set as an area that includes the image of both eyes. Then, in regard to each of the evaluation directions, an evaluation value is calculated on the basis of pixel values of the image of the evaluation specific area ESA, and then the inclination of the face area FA is adjusted using the adjustment angle of inclination determined on the basis of the evaluation values.

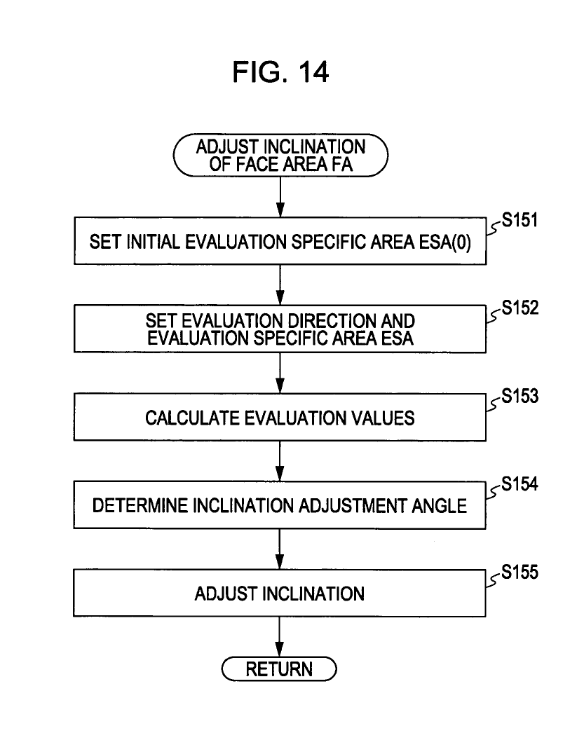

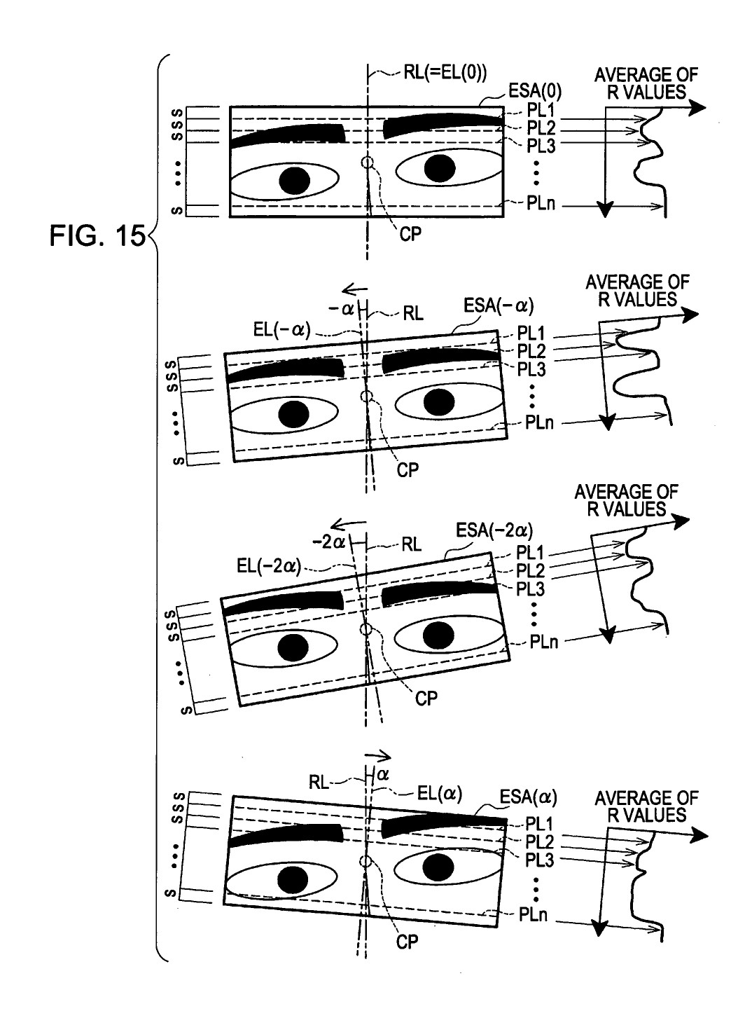

FIG. 14 is a flowchart that shows the flow of an inclination adjustment process in which the inclination of the face area FA is adjusted according to the present example embodiment. In addition, FIG. 15 is a view that illustrates one example of a method of calculating evaluation values used for adjusting the inclination of the face area FA. In step S151 (FIG. 14), the specific area setting unit 232 (FIG. 1) sets an initial evaluation specific area ESA(0). The initial evaluation specific area ESA(0) is an evaluation specific area ESA that is associated with a direction (hereinafter, also referred to as “initial evaluation direction”) parallel to the reference line RL (see FIG. 13) that is obtained after the position of the face area FA has been adjusted. In the present example embodiment, the specific area SA (see FIG. 13) corresponding to the face area FA of which the position has been adjusted is set as the initial evaluation specific area ESA(0) as it is. Note that the evaluation specific area ESA used for adjusting the inclination of the face area FA is different from the specific area SA that is used when the position of the face area FA is adjusted and is not divided into two right and left areas. The set initial evaluation specific area ESA(0) is shown in the uppermost drawing of FIG. 15.

In step S152 (FIG. 14), the specific area setting unit 232 (FIG. 1) sets a plurality of evaluation directions and an evaluation specific area ESA corresponding to each of the evaluation directions. The plurality of evaluation directions are set as directions that represent the choices of adjustment angles of inclination. In the present example embodiment, a plurality of evaluation direction lines EL, from which an angle that is made with the reference line RL falls within a predetermined range, are set, and directions parallel to the evaluation direction lines EL are set as evaluation directions. As shown in FIG. 15, straight lines are determined in such a manner that the reference line RL is rotated about the center point (center of gravity) CP of the initial evaluation specific area ESA(0) on a predetermined angle α basis in a counterclockwise direction or in a clockwise direction. Then, the thus determined straight lines are set as the plurality of evaluation direction lines EL. Note that the evaluation direction line EL of which an angle that is made with the reference line RL is +degrees is denoted as EL(φ).

In the present example embodiment, the above described predetermined range with respect to an angle that is made by each evaluation direction line EL with the reference line RL is set to a range of ±20 degrees. Here, in this description, a rotation angle is indicated by a positive value when the reference line RL is rotated in a clockwise direction, and a rotation angle is indicated by a negative value when the reference line RL is rotated in a counterclockwise direction. The specific area setting unit 232 rotates the reference line RL in a counterclockwise direction or in a clockwise direction while increasing a rotation angle like α degrees, 2α degrees, . . . within a range that does not exceed 20 degrees to thereby set the plurality of evaluation direction lines EL. FIG. 15 shows the evaluation direction lines EL (EL(−α), EL(−2α), EL(α)) that are respectively determined by rotating the reference line RL at −α degrees, −2α degrees, and α degrees. Note that the reference line RL may also be expressed as an evaluation direction line EL(0).

The evaluation specific area ESA corresponding to the evaluation direction line EL that represents each of the evaluation directions is an area that is obtained by rotating the initial evaluation specific area ESA(0) about the center point CP at the same angle as the rotation angle at which the evaluation direction line EL is set. The evaluation specific area ESA corresponding to the evaluation direction line EL(φ) is denoted as an evaluation specific area ESA(φ). FIG. 15 shows the evaluation specific areas ESA (ESA(−α), ESA(−2α), and ESA(α)) that respectively correspond to the evaluation direction lines EL(−α), EL(−2α), and EL(α). Note that the initial evaluation specific area ESA(0) is also treated as one of the evaluation specific areas ESA.

In step S153 (FIG. 14), the evaluation unit 234 (FIG. 1) calculates an evaluation value on the basis of pixel values of an image of the evaluation specific area ESA with respect to each of the plurality of set evaluation directions. In the present example embodiment, the average values of R values are used as evaluation values for adjusting the inclination of the face area FA as in the case of the above described evaluation value for adjusting the position of the face area FA. The evaluation unit 234 calculates an evaluation value for each of the plurality of evaluation positions located along the evaluation direction.

The method of calculating the evaluation value is the same as the above described method of calculating the evaluation value for adjusting the position of the face area FA. That is, the evaluation unit 234, as shown in FIG. 15, sets the target pixel specifying lines PL1 to PLn perpendicular to the evaluation direction line EL within each of the evaluation specific areas ESA, selects the evaluation target pixels TP with respect to each of the target pixel specifying lines PL1 to PLn, and then calculates the average of R values of the selected evaluation target pixels TP as an evaluation value.

A method of setting the target pixel specifying lines PL within the evaluation specific area ESA and a method of selecting the evaluation target pixels TP are the same as the method of adjusting the position of the face area FA shown in FIG. 9, FIG. 10A and FIG. 10B except whether an area is divided into right and left areas. Note that, as in the case of the adjustment of the position of the face area FA, a portion of the selected evaluation target pixels TP (for example, 0.75 k pixels having relatively large R values among the evaluation target pixels TP) may be excluded from the calculation of evaluation values. On the right side of FIG. 15, in regard to each of the evaluation directions, a distribution of the calculated evaluation values along the evaluation direction line EL is shown.

Note that the target pixel specifying line PL is a straight line perpendicular to the evaluation direction line EL, so that the evaluation values may be calculated with respect to a plurality of positions (evaluation positions) along the evaluation direction line EL. In addition, the evaluation value may be regarded as a value that represents the characteristics of a distribution of pixel values along the direction perpendicular to the evaluation direction line EL with respect to each of the evaluation positions.

In step S154 (FIG. 14), the determination unit 236 (FIG. 1) determines an adjustment angle that is used to adjust the inclination of the face area FA. With respect to each of the evaluation directions, the determination unit 236 calculates a distribution of the evaluation values, calculated in step S153, along the evaluation direction line EL and selects an evaluation direction that has a maximum variance. Then, an angle made by the evaluation direction line EL, which corresponds to the selected evaluation direction, with the reference line RL is determined as an adjustment angle used for adjusting the inclination.

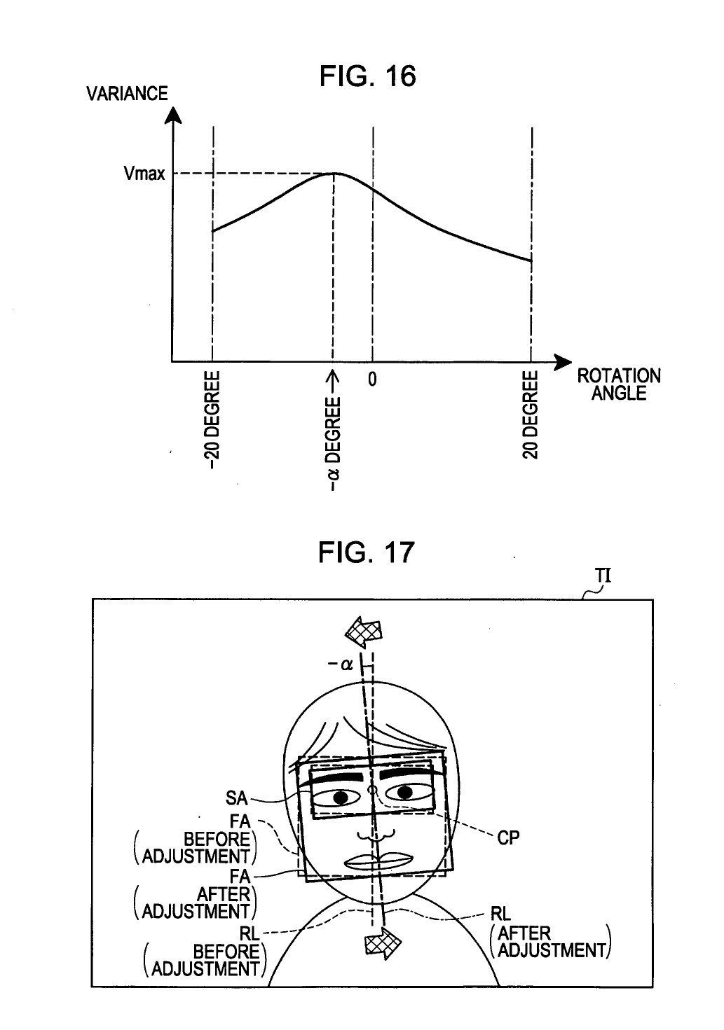

FIG. 16 is a view that illustrates one example of the calculation result of a variance of evaluation values with respect to each evaluation direction. In the example shown in FIG. 16, the variance takes a maximum value Vmax in the evaluation direction of which the rotation angle is −α degrees. Thus, −α degrees, that is, a rotation angle of α degrees in a counterclockwise direction, is determined as an adjustment angle used for adjusting the inclination of the face area FA.

The reason why an angle corresponding to the evaluation direction in which the value of variance of evaluation values becomes maximum is determined as an adjustment angle used for adjusting the inclination will be described. As shown by the second drawing of FIG. 15 from the top, in the evaluation specific area ESA(−α) in which the rotation angle is −α degrees, the images of the center portions (black eye portions) of right and left eyes are arranged so that they are aligned in a direction substantially parallel to the target pixel specifying line PL (that is, a direction perpendicular to the evaluation direction line EL). In addition, at this time, similarly, the images of right and left eyebrows are also arranged so that they are aligned in a direction substantially perpendicular to the evaluation direction line EL. Accordingly, the evaluation direction corresponding to the evaluation direction line EL at this time may be regarded as a direction that substantially represents the inclination of a face image. At this time, the positional relationship between the image of eyes or eyebrows generally having small R values and the image of a skin portion generally having large R values will be a positional relationship in which both of the images have less overlapping portions along the direction of the target pixel specifying line PL. Therefore, the evaluation value at a position of the image of eyes or eyebrows is relatively small, and the evaluation value at a position of the image of a skin portion is relatively large. Thus, the distribution of evaluation values along the evaluation direction line EL will be a distribution having a relatively large dispersion (large amplitude), as shown in FIG. 15, and the value of variance becomes large.

On the other hand, as shown in the top, third from the top and fourth from the top drawings of FIG. 15, in the evaluation specific areas ESA(0), ESA(−2α), and ESA(α) in which the rotation angles are respectively 0 degree, −2α degrees, and α degrees, the images of the center portions of right and left eyes or the images of right and left eyebrows are not aligned in a direction perpendicular to the evaluation direction line EL but deviated from each other. Thus, the evaluation direction corresponding to the evaluation direction line EL at this time does not represent the inclination of the face image. At this time, the positional relationship between the image of eyes or eyebrows generally having small R values and the image of a skin portion generally having large R values will be a positional relationship in which both of the images have many overlapping portions along the direction of the target pixel specifying line PL. Thus, the distribution of evaluation values along the evaluation direction line EL will be a distribution having a relatively small dispersion (small amplitude), as shown in FIG. 15, and the value of variance becomes small.

As described above, when the evaluation direction is close to the direction of inclination of the face image, the value of a variance of the evaluation values along the evaluation direction line EL becomes large, and, when the evaluation direction is remote from the direction of inclination of the face image, the value of a variance of the evaluation values along the evaluation direction line EL becomes small. Thus, when an angle corresponding to the evaluation direction in which the value of a variance of the evaluation values becomes maximum is determined as an adjustment angle used for adjusting the inclination, it is possible to make the inclination of the face area FA conform to the inclination of the face image.

Note that, in the present example embodiment, when the calculation result of the variance of the evaluation values is a critical value within the range of angles, that is, the calculation result becomes a maximum value at an angle of −20 degrees or 20 degrees, it may be presumed that the inclination of a face is probably not properly evaluated. Thus, the adjustment of inclination of the face area FA is not executed in this case.

In addition, in the present example embodiment, the determined adjustment angle is compared with the approximate inclination angle RI that has been calculated when the position of the face area FA is adjusted as described above. When a difference between the adjustment angle and the approximate inclination angle RI is larger than a predetermined threshold value, it may be presumed that an error has occurred when evaluation or determination has been made in adjusting the position of the face area FA or in adjusting the inclination thereof. Thus, the adjustment of position of the face area FA and the adjustment of inclination thereof are not executed in this case.

In step S155 (FIG. 14), the face area adjustment unit 230 (FIG. 1) adjusts the inclination of the face area FA. FIG. 17 is a view that illustrates one example of a method of adjusting the inclination of the face area FA. The adjustment of inclination of the face area FA is performed in such a manner that the face area FA is rotated about the center point CP of the initial evaluation specific area ESA(0) by the adjustment angle that is determined in step S154. In the example of FIG. 17, by rotating the face area FA of which the angle has not yet been adjusted, indicated by the broken line, in a counterclockwise direction by α degrees, the face area FA of which the angle has been adjusted, indicated by the solid line, is set.

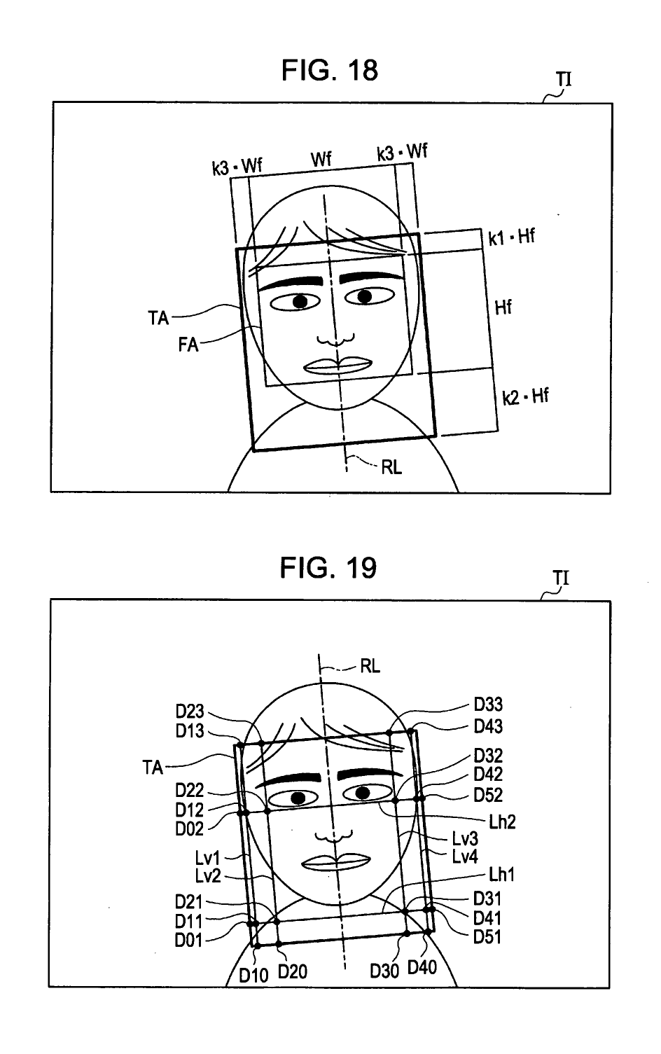

In step 160 (FIG. 4) after the adjustment of inclination of the face area FA has been completed, the deformation area setting unit 240 (FIG. 1) sets a deformation area TA. The deformation area TA is an area on the target image TI and is an area on which image deformation process is performed for face shape correction. FIG. 18 is a view that illustrates one example of a method of setting the deformation area TA. As shown in FIG. 18, in the present example embodiment, the deformation area TA is set as an area such that the face area FA is extended (or contracted) in a direction parallel to the reference line RL (height direction) and in a direction perpendicular to the reference line RL (width direction). Specifically, where the size of the face area FA in the height direction is Hf, the size of the face area FA in the width direction is Wf, an area that is obtained by extending the face area FA upward by an amount of k1·Hf and downward by an amount of k2·Hf and by extending the face area FA to the right side and to left side, respectively, by an amount of k3·Wf is set as the deformation area TA. Note that k1, k2, and k3 are predetermined coefficients.

When the deformation area TA is set in this manner, the reference line RL, which is a straight line parallel to the contour line of the face area FA in the height direction, will be a straight line that is also parallel to the contour line of the deformation area TA in the height direction. In addition, the reference line RL becomes a straight line that divides the width of the deformation area TA in half.

As shown in FIG. 18, the deformation area TA is set as an area that includes the image substantially from the jaw to the forehead with respect to the height direction and that also includes the images of right and left cheeks with respect to the width direction. That is, in the present example embodiment, the above coefficients k1, k2, and k3 are set in advance on the basis of the relationship with the size of the face area FA so that the deformation area TA becomes an area that substantially includes the image of the above described range.

In step S170 (FIG. 4), the deformation area dividing unit 250 (FIG. 1) divides the deformation area TA into a plurality of small areas. FIG. 19 is a view that illustrates one example of a method of dividing the deformation area TA into small areas. The deformation area dividing unit 250 arranges a plurality of dividing points D in the deformation area TA and then divides the deformation area TA into a plurality of small areas using the straight lines that connect the dividing points D.

The mode of arrangement of the dividing points D (the number and positions of the dividing points D) is defined in the dividing point arrangement pattern table 410 (FIG. 1) in association with a deformation type that is set in step S120 (FIG. 4). The deformation area dividing unit 250 references the dividing point arrangement pattern table 410 and then arranges dividing points D in the mode that is associated with the deformation type set in step S120. In the present example embodiment, as described above, because the deformation “type A” (see FIG. 5) for sharpening a face is set as the deformation type, the dividing points D are arranged in the mode that is associated with this deformation type.

As shown in FIG. 19, the dividing points D are arranged at intersections of horizontal dividing lines Lh and vertical dividing lines Lv and at intersections of the horizontal dividing lines Lh or vertical dividing lines Lv and the outer frame line of the deformation area TA. Here, the horizontal dividing lines Lh and the vertical dividing lines Lv are reference lines for arranging the dividing points D in the deformation area TA. As shown in FIG. 19, in arranging the dividing points D that are associated with the deformation type for sharpening a face, two horizontal dividing lines Lh perpendicular to the reference line RL and four vertical dividing lines Lv parallel to the reference line RL are set. The two horizontal lines Lh are denoted as Lh1, Lh2 in the order from the lower side of the deformation area TA. In addition, the four vertical dividing lines Lv are denoted as Lv1, Lv2, Lv3, and Lv4 in the order from the left side of the deformation area TA.

In the deformation area TA, the horizontal dividing line Lh1 is arranged on the lower side relative to the image of the jaw, and the horizontal dividing line Lh2 is arranged immediately below the images of the eyes. In addition, the vertical dividing lines Lv1 and Lv4 each are arranged outside the image of the line of the cheek, and the vertical dividing lines Lv2 and Lv3 each are arranged outside the image of the outer corner of the eye. Note that the arrangement of the horizontal dividing lines Lh and vertical dividing lines Lv is executed in accordance with association with the size of the deformation area TA that is set in advance so that the positional relationship between the horizontal dividing lines Lh or vertical dividing lines Lv and the image eventually becomes the above described positional relationship.

In accordance with the above described arrangement of the horizontal dividing lines Lh and vertical dividing lines Lv, the dividing points D are arranged at the intersections of the horizontal dividing lines Lh and the vertical dividing lines Lv and at the intersections of the horizontal dividing lines Lh or vertical dividing lines Lv and the outer frame line of the deformation area TA. As shown in FIG. 19, the dividing points D that are located on the horizontal dividing line Lhi (i=1 or 2) are denoted as D0i, D1i, D2i, D3i, D4i, and D5i in the order from the left side. For example, the dividing points D that are located on the horizontal dividing line Lh1 are denoted as D01, D11, D21, D31, D41, and D51. Similarly, the dividing points that are located on the vertical dividing line Lvj (j=any one of 1, 2, 3, and 4) are denoted as Dj0, Dj1, Dj2, and Dj3 in the order from the lower side. For example, the dividing points D that are located on the vertical dividing line Lv1 are denoted as D10, D11, D12, and D13.

Note that, as shown in FIG. 19, the dividing points D in the present example embodiment are arranged symmetrically with respect to the reference line RL.

The deformation area dividing unit 250 divides the deformation area TA into a plurality of small areas using the straight lines that connect the arranged dividing points D (that is, the horizontal dividing lines Lh and the vertical dividing lines Lv). In the present example embodiment, as shown in FIG. 19, the deformation area TA is divided into 15 rectangular small areas.

Note that, in the present example embodiment, because the arrangement of the dividing points D is determined on the basis of the number and positions of the horizontal dividing lines Lh and vertical dividing lines Lv, the dividing point arrangement pattern table 410 defines the number and positions of the horizontal dividing lines Lh and vertical dividing lines Lv.

In step S180 (FIG. 4), the deformation processing unit 260 (FIG. 1) executes image deformation process on the deformation area TA of the target image TI. The deformation process executed by the deformation processing unit 260 moves the positions of the dividing points D within the deformation area TA in step S170 and then deforms the small areas.

The moving mode (moving direction and moving distance) of the position of each dividing point D for deformation process is determined in advance in association with the combinations of the deformation type and the degree of deformation, which are set in step S120 (FIG. 4), by the dividing point moving table 420 (FIG. 1). The deformation processing unit 260 references the dividing point moving table 420 and moves the positions of the dividing points D using the moving direction and moving distance that are in association with the combination of the deformation type and the degree of deformation, which are set in step S120.

In the present example embodiment, as described above, the deformation “type A” (see FIG. 5) for sharpening a face is set as the deformation type, and the degree of extent “Middle” is set as the deformation degree, so that the positions of the dividing points D are moved using the moving direction and the moving distance, which are associated with the combination of these deformation type and deformation degree.

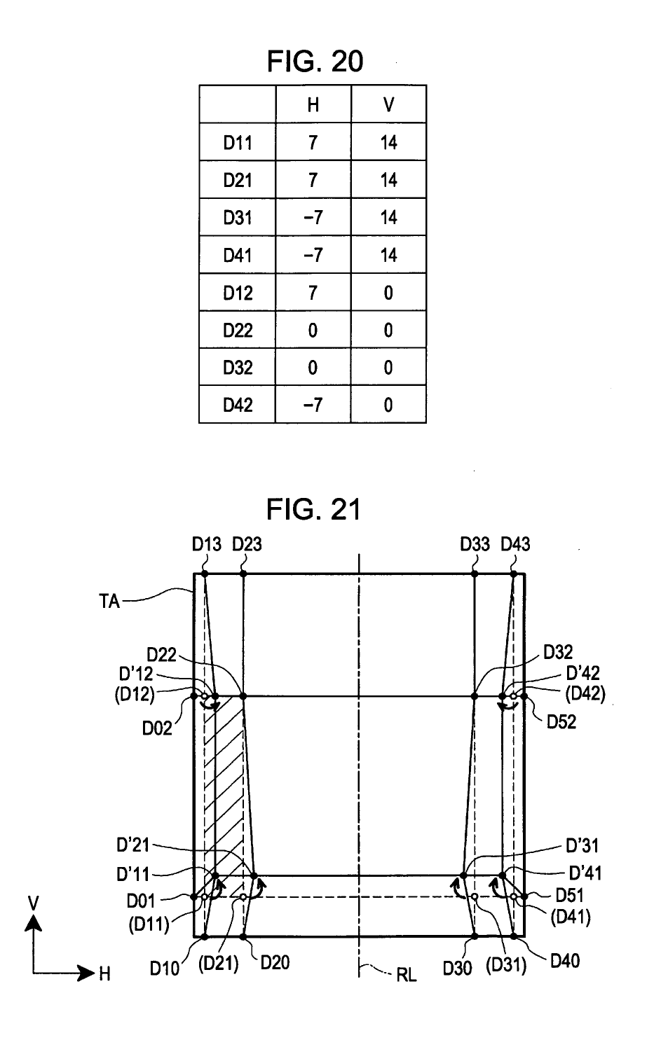

FIG. 20 is a view that illustrates one example of the content of the dividing point moving table 420 (see FIG. 1). In addition, FIG. 21 is a view that illustrates one example of movement of positions of dividing points D in accordance with the dividing point moving table 420. FIG. 20 shows, among the moving modes of the positions of the dividing points D defined by the dividing point moving table 420, a moving mode that is associated with the combination of the deformation type for sharpening a face and the deformation degree of extent “Middle”. As shown in FIG. 20, the dividing point moving table 420 indicates, with respect to each of the dividing points D, the amount of movement along a direction (H direction) perpendicular to the reference line RL and along a direction (V direction) parallel to the reference line RL. Note that, in the present example embodiment, the unit of the amount of movement shown in the dividing point moving table 420 is a pixel pitch PP of the target image TI. In addition, in regard to the H direction, the amount of movement toward the right side is indicated by a positive value and the amount of movement toward the left side is indicated by a negative value, while, in regard to the V direction, the amount of upward movement is indicated by a positive value and the amount of downward movement is indicated by a negative value. For example, the dividing point D11 is moved toward the right side by a distance of seven times the pixel pitch PP along the H direction and is moved upward by a distance of 14 times the pixel pitch PP along the V direction. In addition, for example, the amount of movement of the dividing point D22 is zero in both the H direction and V direction, so that the dividing point D22 will not be moved.

Note that, in the present example embodiment, in order to avoid making the boundary between the images inside and outside the deformation area TA be unnatural, the positions of the dividing points D (for example, the dividing point D10, and the like, shown in FIG. 21) located on the outer frame line of the deformation area TA are not moved. Thus, the dividing point moving table 420 shown in FIG. 20 does not define a moving mode with respect to the dividing points that are located on the outer frame line of the deformation area TA.

FIG. 21 shows the dividing points D that have not yet been moved using the outline circle and shows the dividing points D that have been moved or the dividing points D of which the positions will not be moved using the solid circle. In addition, the dividing points D that have been moved are denoted by dividing points D′. For example, the position of the dividing point Dll is moved in an upper right direction in FIG. 21 and then it will be a dividing point D′11.

Note that, in the present example embodiment, the moving mode is determined so that all the pairs of the dividing points D that are symmetrically located with respect to the reference line RL (for example, the pair of the dividing point D11 and the dividing point D41) maintain the symmetrical positional relationship with respect to the reference line RL even after the dividing points D have been moved.

The deformation processing unit 260 executes image deformation process on each of the small areas that constitute the deformation area TA so that the images of the small areas in a state where the positions of the dividing points D have not yet been moved become images of small areas that are newly defined through the position movement of the dividing points D. For example, in FIG. 21, the image of a small area (small area indicated by hatching) having vertexes of dividing points D11, D21, D22, and D12 is deformed into the image of a small area having vertexes of dividing points D′11, D′21, D22, and D′12.

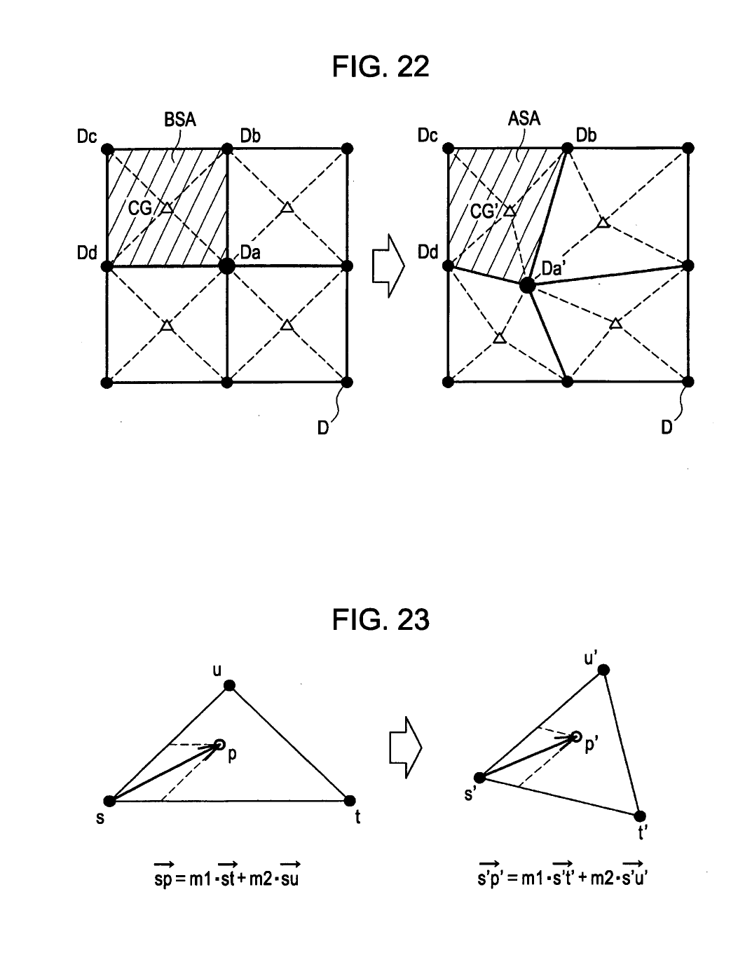

FIG. 22 is a view that illustrates the concept of a deformation processing method of an image using the deformation processing unit 260. In FIG. 22, the dividing points D are shown using solid circles.¹ FIG. 22 shows, with respect to four small areas, the state of dividing points D, of which the positions have not yet been moved, on the left side and the state of dividing points D, of which the positions have been moved, on the right side, respectively, for easy description. In the example shown in FIG. 22, a center dividing point Da is moved to the position of a dividing point Da′, and the positions of the other dividing points will not be moved. In this manner, for example, the image of a rectangular small area (hereinafter, also referred to as “pre-deformation focusing small area BSA”) having the vertexes of dividing points Da, Db, Dc, and Dd of which the positions of the dividing points D have not yet been moved is deformed into the image of a rectangular small area (hereinafter, also referred to as “post-deformation focusing small area ASA”) having the vertexes of the dividing points Da′, Db, Dc, and Dd. I don't see any circles in FIG. 22. Should this be “triangles”?

In the present example embodiment, the rectangular small area is divided into four triangle areas using the center of gravity CG of the rectangular small area, and the image deformation process is executed on a triangle area basis. In the example of FIG. 22, the pre-deformation focusing small area BSA is divided into four triangle areas, each having one of the vertexes at the center of gravity CG of the pre-deformation focusing small area BSA. Similarly, the post-deformation focusing small area ASA is divided into four triangle areas, each having one of the vertexes at the center of gravity CG′ of the post-deformation focusing small area ASA. Then, the image deformation process is executed for each of the triangle areas corresponding to the respective states of the dividing point Da before and after movement. For example, the image of a triangle area that has the vertexes of dividing points Da, Dd and the center of gravity CG within the pre-deformation focusing small area BSA is deformed into the image of a triangle area that has the vertexes of dividing points Da′, Dd and the center of gravity CG′ within the post-deformation focusing small area ASA.

FIG. 23 is a view that illustrates the concept of a method of processing deformation of an image in a triangle area. In the example of FIG. 23, the image of a triangle area stu that has the vertexes of points s, t, and u is deformed into the image of a triangle area s′t′u′ that has the vertexes of points s′, t′, and u′. The deformation of an image is performed in such a manner that which one of the positions in the image of the triangle area stu that has not yet been deformed corresponds to each of the positions of pixels in the image of the triangle area s′t′u′ that has been deformed is calculated, and pixel values in the image that has not yet been deformed at the positions calculated are set to pixel values of the image that has been deformed.

For example, in FIG. 23, the position of a focusing pixel p′ in the image of the triangle area s′t′u′ that has been deformed corresponds to a position p in the image of the triangle area stu that has not yet been deformed. The calculation of the position p is performed in the following manner. First, coefficients m1 and m2 that are used to express the position of the focusing pixel p′ using the sum of a vector s′t′ and a vector s′u′ shown in the following equation (1) are calculated.

\vec{s′p′}=m1·\vec{s′t′}+m2·\vec{s′u′} (1)

Next, using the calculated coefficients m1 and m2, the sum of a vector st and a vector su in the triangle area stu that has not yet been deformed is calculated through the following equation (2) and, as a result, the position p is obtained.

\vec{sp}=m1·\vec{st}+m2·\vec{su} (2)

When the position p in the triangle area stu that has not yet been deformed coincides with a pixel center position of the image that has not yet been deformed, the pixel value of that pixel is set as a pixel value of the image that has been deformed. On the other hand, when the position p in the triangle area stu that has not yet been deformed becomes a position deviated from the pixel center position of the image that has not yet been deformed, a pixel value at the position p is calculated by means of interpolation computing, such as bicubic, that uses the pixel values of pixels around the position p, and then the calculated pixel value is set to a pixel value of the image that has been deformed.

By calculating the pixel value as described above in regard to each pixel of the image in the triangle area s′t′u′ that has been deformed, it is possible to execute image deformation process by which the image of the triangle area stu is deformed into the image of the triangle area s′t′u′. The deformation processing unit 260, in terms of each of the small areas that constitute the deformation area TA shown in FIG. 21, defines the triangle area as described above and executes deformation process, thus executing image deformation process on the deformation area TA.

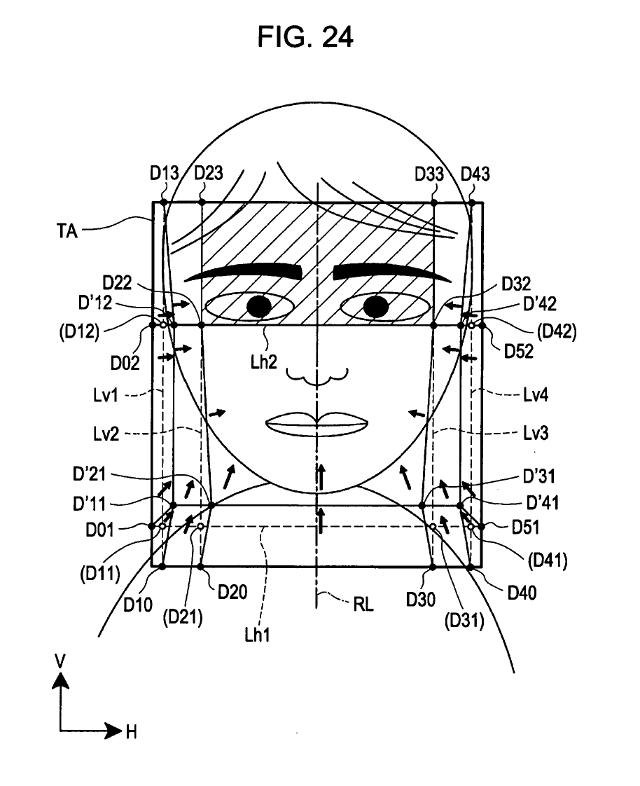

Here, the mode of face shape correction of the present example embodiment will be described in more detail. FIG. 24 is a view that illustrates one mode of face shape correction according to the present example embodiment. In the present example embodiment, as described above, the deformation “type A” (see FIG. 5) for sharpening a face is set as the deformation type, and the degree of extent “Middle” is set as the deformation degree. In FIG. 24, the image of deformation mode of each of the small areas that constitute the deformation area TA is shown by the arrow.

As shown in FIG. 24, in the face shape correction of the present example embodiment, with respect to a direction (V direction) parallel to the reference line RL, the positions of the dividing points D (D11, D21, D31, D41) that are arranged on the horizontal dividing line Lh1 are moved upward, while, on the other hand, the positions of the dividing points D (D12,D22,D32,D42) that are arranged on the horizontal dividing line Lh2 are not moved (see FIG. 20). Thus, the image located between the horizontal dividing line Lh1 and the horizontal dividing line Lh2 is reduced with respect to the V direction. As described above, because the horizontal dividing line Lh1 is arranged on the lower side relative to the image of the jaw, and the horizontal dividing line Lh2 is arranged immediately below the image of the eyes, in the face shape correction of the present example embodiment, within the image of the face, the image of an area extending from the jaw to a portion below the eyes is reduced in the V direction. As a result, the line of the jaw in the image is moved upward.

On the other hand, with respect to a direction (H direction) perpendicular to the reference line RL, the positions of the dividing points D (Dll, D12) that are arranged on the vertical dividing line Lv1 are moved to the right direction, and the positions of the dividing points D (D41, D42) that are arranged on the vertical dividing line Lv4 are moved to the left direction (see FIG. 20). Furthermore, among two dividing points D that are arranged on the vertical dividing line Lv2, the position of the dividing point D (D21) that is arranged on the horizontal dividing line Lh1 is moved to the right direction, and, among two dividing points D that are arranged on the vertical dividing line Lv3, the position of the dividing point D (D31) that is arranged on the horizontal dividing line Lh1 is moved to the left direction (see FIG. 20). Thus, the image that is located on the left side to the vertical dividing line Lv1 is enlarged to the right side with respect to the H direction, and the image on the right side to the vertical dividing line Lv4 is enlarged to the left side with respect to the H direction. In addition, the image that is located between the vertical dividing line Lv1 and the vertical dividing line Lv2 is reduced or moved to the right side with respect to the H direction, and the image that is located between the vertical dividing line Lv3 and the vertical dividing line Lv4 is reduced or moved to the left side with respect to the H direction. Furthermore, the image that is located between the vertical dividing line Lv2 and the vertical dividing line Lv3 is reduced with respect to the H direction using the position of the horizontal dividing line Lh1 as a center.

As described above, the vertical dividing lines Lv1 and Lv4 each are located outside the image of the line of the cheek, the vertical dividing lines Lv2 and Lv3 each are arranged outside the image of the outer corner of the eye. Therefore, in the face shape correction of the present example embodiment, within the image of the face, the images of portions outside both the outer corners of eyes are entirely reduced in the H direction. Particularly, the reduction ratio is high around the jaw. As a result, the shape of the face in the image is entirely narrowed in the width direction.

When the deformation modes in the H direction and in the V direction, described above, are combined, the shape of the face in the target image TI is sharpened through the face shape correction of the present example embodiment. Note that sharpening of the shape of a face may be expressed as so-called becoming a “small face”.

Note that the small areas (hatched areas) having the vertexes at the dividing points D22, D32, D33, and D23 shown in FIG. 24 include the images of both eyes when the above described method of arranging the horizontal dividing line Lh2 and the vertical dividing lines Lv2 and Lv3 is used. As shown in FIG. 20, because the dividing points D22 and D32 are not moved in the H direction or in the V direction, the small area that includes the images of both eyes is not deformed. In the present example embodiment as described above, the small area that includes the images of both eyes is not deformed, so that the image on which face shape correction has been executed becomes more natural and desirable.

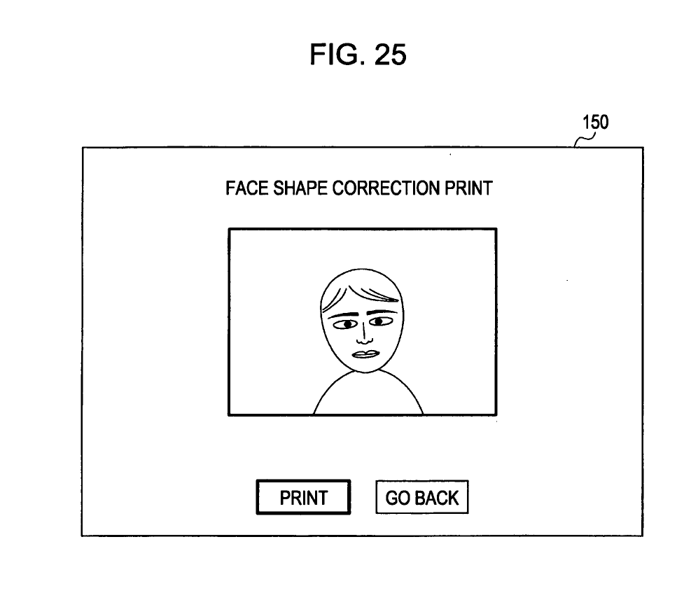

In step S190 (FIG. 4), the face shape correction unit 200 (FIG. 1) instructs the display processing unit 310 to make the display unit 150 display the target image TI on which the face shape correction has been executed. FIG. 25 is a view that illustrates one example of the state of the display unit 150 on which the target image TI, on which the face shape correction has been executed, is displayed. Using the display unit 150 on which the target image TI, on which the face shape correction has been executed, is displayed, a user is able to confirm the result of the correction. When the user is not satisfied with the correction result and then selects “GO BACK” button, for example, the screen to select a deformation type and a deformation degree, shown in FIG. 5, is displayed on the display unit 150. Then, resetting of the deformation type and the deformation degree is performed by the user. When the user is satisfied with the correction result and then selects “PRINT” button, the following corrected image printing process is initiated.

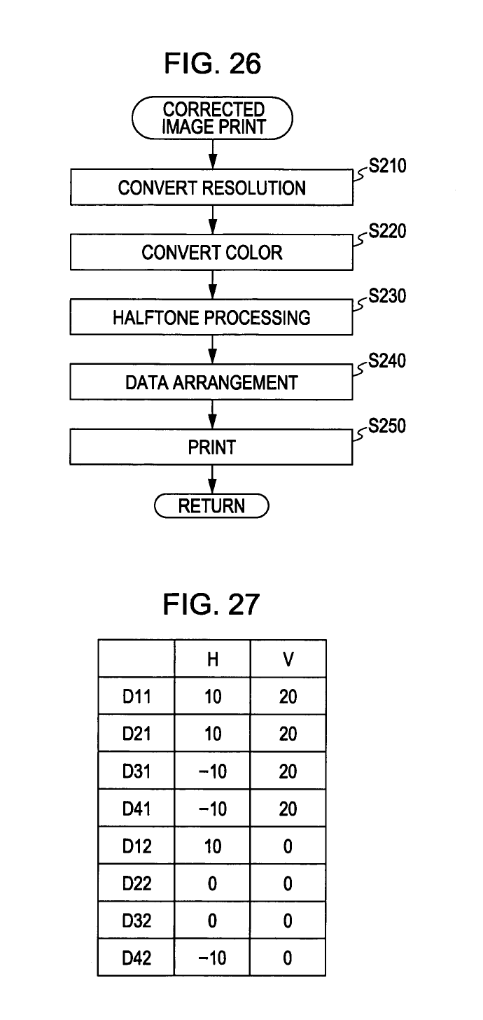

In step S200 (FIG. 3), the print processing unit 320 (FIG. 1) controls the printer engine 160 to thereby print out the target image TI on which the face shape correction process has been executed. FIG. 26 is a flowchart that shows the flow of a corrected image printing process according to the present example embodiment. The print processing unit 320 converts the resolution of image data of the target image TI, on which the face shape correction process has been executed, into a resolution that is suitable for a printing process by the printer engine 160 (step S210), and then converts the image data, of which the resolution has been converted, into ink color image data that are represented by gray scales with a plurality of ink colors used for printing in the printer engine 160 (step S220). Note that, in the present example embodiment, the plurality of ink colors used for printing in the printer engine 160 are four colors, that is, cyan (C), magenta (M), yellow (Y), and black (K). Furthermore, the print processing unit 320 executes a halftone process on the basis of the gray scale value of each ink color in the ink color image data to thereby generate dot data that represent the state of formation of ink dots for each printing pixel (step S230), and then generates printing data by arranging the dot data (step S240). The print processing unit 320 supplies the generated print data to the printer engine 160 and then makes the printer engine 160 print out the target image TI (step S250). In this manner, printing of the target image TI, on which the face shape correction has been executed, is completed.

### A-3. Alternative Embodiment to First Example Embodiment

In the first example embodiment, the face shape correction process, when the deformation “type A” (see FIG. 5) for sharpening a face is set as the deformation type and the degree of extent “Middle” is set as the deformation degree, is described. When these settings differ from those of the first example embodiment, different face shape correction printing process is executed.

As described above, the moving mode (moving direction and moving distance) of the positions of the dividing points D for deformation process is determined in association with the combinations of deformation types and deformation degrees in the dividing point moving table 420 (FIG. 1). Thus, for example, when the extent “Strong” is set as the deformation degree in place of the extent “Middle”, the dividing points D are moved in the moving mode that is associated with the extent “Strong”, determined in the dividing point moving table 420.

FIG. 27 is a view that illustrates another example of the content of the dividing point moving table 420. FIG. 27 shows the moving mode of which the positions of the dividing points D are associated with the combination of the deformation type for sharpening a face and the deformation degree of extent “Strong”. In the moving mode shown in FIG. 27, the values of moving distances in the H direction and in the V direction are large in comparison with the moving mode that is associated with the combination of the deformation type for sharpening a face and the deformation degree “Middle”, shown in FIG. 20. Thus, when the extent “Strong” is set as the deformation degree, among the small areas that constitute the deformation area TA, the amount of deformation of the small areas deformed is large and, as a result, the shape of the face in the target image TI becomes relatively sharp.

In addition, as described above, the mode of arrangement of the dividing points D (the number and positions of the dividing points D) in the deformation area TA is defined in association with the set deformation type in the dividing point arrangement pattern table 410 (FIG. 1). Thus, for example, when the deformation “type B” for enlarging eyes (see FIG. 5) is set as the deformation type in place of the deformation type for sharpening a face, the dividing points D will be arranged in the mode in association with the deformation type for enlarging eyes.

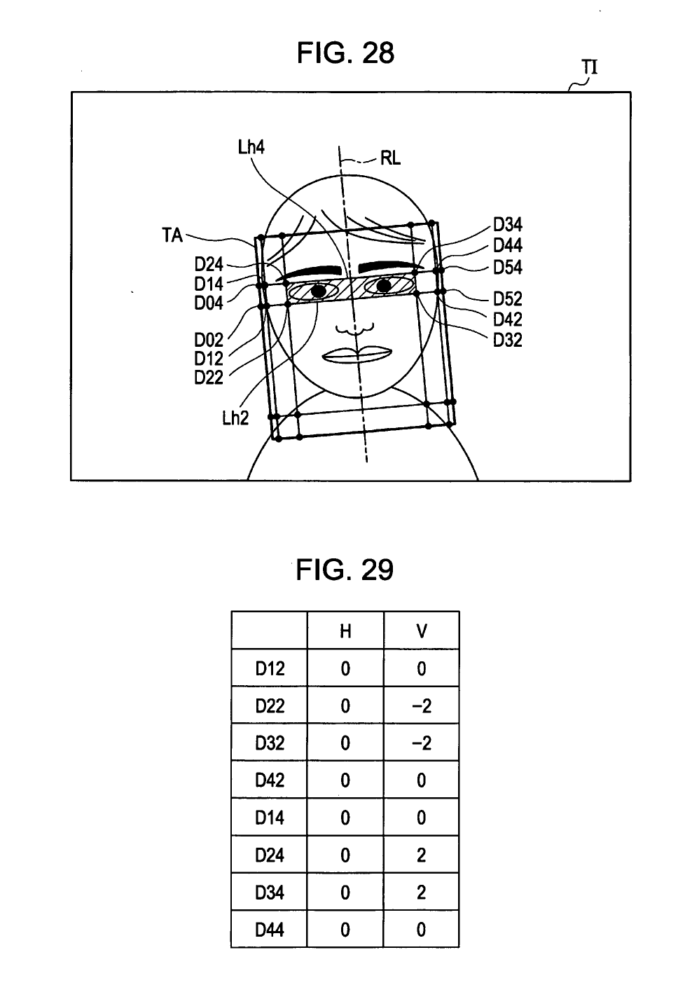

FIG. 28 is a view that illustrates another example of a method of arranging the dividing points D. FIG. 28 shows the mode of arrangement of the dividing points D in association with the deformation type for enlarging eyes. The arrangement of the dividing points D, shown in FIG. 28, is such that six dividing points D (D04, D14, D24, D34, D44, D54) that are located on the horizontal dividing line Lh4 are additionally arranged in comparison with the arrangement of dividing points associated with the deformation type for sharpening a face, shown in FIG. 19. Note that the horizontal dividing line Lh4 is arranged at a position immediately above the images of eyes.

FIG. 29 is a view that illustrates yet another example of the content of the dividing point moving table 420. FIG. 29 shows the moving mode of which the positions of the dividing points D are associated with the combination of the deformation type for enlarging eyes and the deformation degree of extent “Middle”. Note that FIG. 29 specifically shows the moving mode only in relation to the dividing points D arranged on the horizontal dividing line Lh2 and the dividing points D arranged on the horizontal dividing line Lh4 (FIG. 28). Any dividing point D, other than the dividing points shown in FIG. 29, will not be moved.

When the dividing points D are moved in accordance with the mode shown in FIG. 29, the image of the rectangular small area (hatched area in FIG. 28) having the vertexes at the dividing points D22, D32, D34, and D24 is enlarged along a direction parallel to the reference line RL. Thus, the shape of each eye in the target image TI is enlarged vertically.

In addition, as described above, in the present example embodiment, when a user desires to use the user interface shown in FIG. 5, the user specifies the deformation mode in detail. In this case, after the dividing points D have been arranged in accordance with the pattern that is associated with the set deformation type (step S170 in FIG. 4), the user specifies the moving mode of the dividing points D.

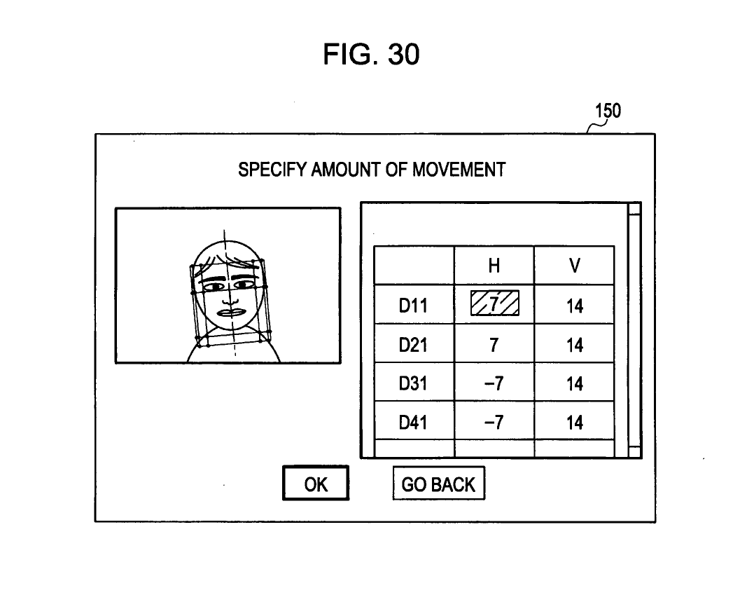

FIG. 30 is a view that illustrates one example of a user interface by which the user specifies the moving mode of the dividing points D. When the user desires to specify the deformation mode in detail, the specification acquiring unit 212 (FIG. 1) of the printer 100, after the arrangement of the dividing points D has been completed, instructs the display processing unit 310 to display the user interface shown in FIG. 30 on the display unit 150. In the user interface shown in FIG. 30, the image that indicates the arrangement of the dividing points D in the deformation area TA of the target image TI is displayed on the left side, and the interface used to specify the moving mode of the dividing points D is arranged on the right side. The user is able to selectively specify the amount of movement of each dividing point D in the H direction and/or in the V direction through this user interface. The deformation processing unit 260 (FIG. 1) moves the dividing points D in accordance with the moving mode that is specified through the user interface, thus executing the deformation process.

Note that, in the user interface shown in FIG. 30, in the initial state, the default amount of movement of each dividing point D in the H direction and in the V direction is determined in accordance with the set deformation type (for example, the deformation type for sharpening a face), and the user changes the amount of movement with respect to a desired dividing point D. According to the above manner, the user is able to minutely specify the amount of movement while referencing the default amount of movement, so that it is possible to achieve the image deformation process in which the image deformation of a desired deformation type is minutely adjusted.

As described above, in the face shape correction printing process by the printer 100 of the present example embodiment, a plurality of dividing points D are arranged in the deformation area TA that is set on the target image TI, and the deformation area TA is divided into a plurality of small areas using straight lines that connect the dividing points D each other (the horizontal dividing lines Lh and the vertical dividing lines Lv). In addition, the deformation process of the image in the deformation area TA is executed in such a manner that the positions of the dividing points D are moved and thereby the small areas are deformed. In this manner, in the face shape correction printing process by the printer 100 of the present example embodiment, it is possible to perform image deformation only by arranging the dividing points D in the deformation area TA and moving the arranged dividing points D. Thus, it is possible to easily and effectively realize image deformation in various deformation modes.

In addition, in the face shape correction printing process by the printer 100 of the present example embodiment, the dividing points D are arranged in accordance with the arrangement pattern that is associated with the deformation type selected or set from among the plurality of deformation types. Therefore, the arrangement of the dividing points D, that is, dividing of the deformation area TA, suitable for each of the deformation types, such as a deformation type for sharpening a face or a deformation type for enlarging eyes, is performed. Thus, it is possible to further easily achieve image deformation of each deformation type.

In addition, in the face shape correction printing process by the printer 100 of the present example embodiment, the dividing points D are moved in accordance with the moving mode (moving direction and amount of movement) that is associated with the combination of the selected or set deformation type and deformation degree. Therefore, when the deformation type and deformation degree are set, the image deformation in accordance with the combination of them is executed. Thus, it is possible to further easily achieve image deformation.

In addition, in the face shape correction printing process by the printer 100 of the present example embodiment, the dividing points D arranged in the deformation area TA are arranged symmetrically with respect to the reference line RL, the moving mode of the dividing points D is determined so that all the pairs of the dividing points D that are symmetrically located with respect to the reference line RL maintain the symmetrical positional relationship with respect to the reference line RL after the dividing points D have been moved. Therefore, in the face shape correction printing process of the present example embodiment, image deformation of which the image is bilaterally symmetrical with respect to the reference line RL is executed, so that it is possible to achieve image deformation of a face image further naturally and desirably.

In addition, in the face shape correction printing process by the printer 100 of the present example embodiment, a portion of small areas among the plurality of small areas that constitute the deformation area TA may be not deformed. That is, as shown in FIG. 24, the arrangement and moving mode of the dividing points D may be set so that the small areas that include the images of both eyes are not deformed. In this manner, by not deforming the small areas that include the images of both eyes, it is possible to achieve image deformation of a face image further naturally and desirably.

In addition, in the face shape correction printing process by the printer 100 of the present example embodiment, when the user desires to specify the deformation mode in detail, the amount of movement of each dividing point D in the H direction and/or in the V direction is specified through the user interface and, in accordance with the specification, the positions of the dividing points D are moved. Therefore, it is possible to easily achieve image deformation in a mode that conforms to the desire of the user as much as possible.

In addition, in the face shape correction printing process by the printer 100 of the present example embodiment, before the deformation area TA is set (step S130 in FIG. 4), the position of the detected face area FA is adjusted along the height direction (step S140 in FIG. 4). Therefore, it is possible to set the face area FA that is further suitable for the position of the image of a face in the target image TI and, therefore, it is possible to make the result of image deformation process on the deformation area TA that is set on the basis of the face area FA be more desirable.

In addition, the position adjustment of the face area FA in the present example embodiment is executed with reference to the positions of the images of eyes, as a reference subject, along the reference line RL. In the present example embodiment, because, in the specific area SA that is set as an area including the images of eyes, the evaluation value that represents the characteristics of a distribution of pixel values along a direction perpendicular to the reference line RL is calculated for each of the plurality of evaluation positions arranged along the reference line RL, it is possible to detect the position of the images of eyes along the reference line RL on the basis of the calculated evaluation values.

More specifically, it is possible to detect the position of the images of eyes in such a manner that the evaluation target pixels TP are selected with respect to each of the plurality of target pixel specifying lines PL perpendicular to the reference line RL and then the average of R values of the evaluation target pixels TP is set as the evaluation value for each target pixel specifying line PL.

In addition, the detection of the position of the image of an eye is performed separately on the left divided specific area SA(1) and the right divided specific area SA(r), each of which is set to include the image of one eye. Therefore, in comparison with the case in which the detection of positions of the images of eyes is performed on the entire specific area SA, it is possible to remove the influence of positional deviation between right and left eyes along the reference line RL and thereby possible to improve the detection accuracy.

In addition, when the evaluation values are calculated for detecting the positions of the images of eyes, with respect to each of the target pixel specifying lines PL, a portion of pixels having large R values among the plurality of selected evaluation target pixels TP are excluded from calculation of evaluation values. Therefore, by excluding a portion of evaluation target pixels TP of which a color is regarded to be largely different from the image of an eye, which serves as a reference subject, from calculation of evaluation values, it is possible to further improve the position detection accuracy of the images of eyes.

In addition, in the face shape correction printing process by the printer 100 of the present example embodiment, before the deformation area TA is set (step S130 in FIG. 4), the inclination of the face area FA is adjusted (step S150 in FIG. 4). Therefore, it is possible to set the face area FA further suitable for the inclination of the image of the face in the target image TI and, therefore, it is possible to obtain the result of image deformation process on the deformation area TA that is set on the basis of the face area FA more desirably.

In addition, the adjustment of inclination of the face area FA in the present example embodiment is executed with reference to the inclination of the images of both eyes as a reference subject. In the present example embodiment, the area that includes the images of both eyes is set as the evaluation specific area ESA in association with each of the plurality of evaluation direction lines EL that are obtained by rotating the reference line RL at various angles. Then, in each of the evaluation specific areas ESA, with respect to each of the plurality of evaluation positions arranged along the evaluation direction, the evaluation value that represents the characteristics of pixel values along a direction perpendicular to the evaluation direction is calculated. Therefore, it is possible to detect the inclination of the images of both eyes on the basis of the calculated evaluation values.

More specifically, with respect to each of the evaluation specific areas ESA, the evaluation target pixels TP are selected for each of the plurality of target pixel specifying lines PL perpendicular to the evaluation direction line EL, the average of R values of the evaluation target pixels TP is calculated as the evaluation value of each target pixel specifying line PL, and the evaluation direction of which the variance of the evaluation values becomes maximum is determined. Thus, it is possible to detect the inclination of the images of both eyes.

In addition, when the evaluation values for detecting the inclination of the images of both eyes are calculated, with respect to each of the target pixel specifying lines PL, a portion of pixels having large R values among the plurality of selected evaluation target pixels TP are excluded from calculation of evaluation values. Therefore, by excluding a portion of evaluation target pixels TP of which a color is regarded to be largely different from the images of both eyes, which serve as a reference subject, are excluded from calculation of evaluation values, it is possible to further improve the position detection accuracy of the images of both eyes.

In addition, in the face shape correction printing process by the printer 100 of the present example embodiment, each of the plurality of small areas that constitute the deformation area TA is divided into four triangle areas and then the image deformation process is executed on a triangle area basis. At this time, respectively before deformation and after deformation, dividing of each small area into four triangles is performed using a line segment that connects each vertex of the small area with the center of gravity CG (CG′). The position of the center of gravity of each small area may be calculated from the coordinates of four vertexes. Therefore, in comparison with the case where the deformation area TA is directly divided into triangle small areas, it is possible to reduce the number of coordinates specified and, as a result, it is possible to attempt to increase throughput. In addition, when the image deformation is performed without dividing small areas into triangles, depending on the moving direction and amount of movement of each vertex (dividing point D) of the small areas, there is a possibility that the shape may include a small area that has an interior angle above 180 degrees and thereby may obstruct the deformation processing. In the present example embodiment, because the deformation process is executed by dividing the small areas into triangles, it is possible to prevent the occurrence of such inconvenience and thereby it is possible to achieve smooth and stable process.

### B. Other Alternative Embodiments

Note that the aspects of the invention are not limited to the example embodiment or embodiment described above, but they may be modified into various alternative embodiments without departing from the scope of the appended claims. The following alternative embodiments are, for example, applicable.

### B1. First Alternative Embodiment

In the above example embodiment, the average of R values with respect to each of the target pixel specifying lines PL is used as the evaluation value when the position and/or inclination of the face area FA are adjusted (see FIG. 9 and FIG. 15); however, as far as a value that represents the distribution of pixel values along a direction of the target pixel specifying line PL (that is, a direction perpendicular to the reference line RL), another value may be used as the evaluation value. For example, the average of luminance values or the average of edge amounts may be used. The portions of the images of eyes, which serve as a reference subject, may be regarded to be largely different in luminance value and edge amount from the image of a skin portion therearound, so that these values may also be used as the evaluation value.

In addition, in regard to these values, not the average of pixels used for calculation of evaluation values but an accumulated value, the number of pixels that have a value equal to or less than (or more than) a threshold value, or the like, may be used. For example, with respect to each of the target pixel specifying lines PL, the accumulated value of R values or the number of pixels having an R value that is equal to or less than a threshold value may be used as the evaluation value. In addition, in the above example embodiment, with respect to each of the target pixel specifying lines PL, a portion of the evaluation target pixels TP are not used for calculation of evaluation values; however, each of the evaluation values may be calculated using all the evaluation target pixels TP.

In addition, in the above example embodiment, the average of R values is used as the evaluation value, presuming that the process is intended for an Asian race; however, when the process is intended for other human races (white race or black race), other evaluation values (for example, luminance, lightness, B value, or the like) may be used.

### B2. Second Alternative Embodiment

In the above example embodiment, when the position or inclination of the face area FA is adjusted, n target pixel specifying lines PL are set for the specific area SA or the evaluation specific area ESA, and the evaluation value is calculated at the position of each target pixel specifying line PL (see FIG. 9 and FIG. 15). However, it is not necessary to fix the number of the set target pixel specifying lines PL to n, but it may be variably set in accordance with the size of the specific area SA or evaluation specific area ESA to the target image TI. For example, the pitch s of the target pixel specifying lines PL may be fixed, and the number of target pixel specifying lines PL may be set in accordance with the size of the specific area SA or evaluation specific area ESA.

### B3. Third Alternative Embodiment

In the above example embodiment, when the inclination of the face area FA is adjusted, the evaluation directions are set in a range of 20 degrees in a clockwise direction and in a counterclockwise direction with respect to the direction of the reference line RL (see FIG. 15); however, the evaluation directions may be set in a range of 20 degrees in a clockwise direction and in a counterclockwise direction with respect to the direction of the approximate inclination angle RI that is calculated when the position of the face area FA is adjusted.

In addition, in the example embodiment, the evaluation directions are set at a pitch of constant angle α; however, the pitch of the plurality of evaluation directions may be not necessarily constant. For example, the evaluation directions having a narrow pitch may be set in a range close to the direction of the reference line RL, and the evaluation directions having a wide pitch may be set in a range remote from the direction of the reference line RL.

In addition, in the example embodiment, when the inclination of the face area FA is adjusted, the specific area SA corresponding to the face area FA of which the position has been adjusted is set as the initial evaluation specific area ESA(0); however, the initial evaluation specific area ESA(0) may be set independently of the specific area SA.

### B4. Fourth Alternative Embodiment

In the above example embodiment, when the inclination of the face area FA is adjusted, the plurality of evaluation directions are set, and the evaluation specific area ESA corresponding to the evaluation direction line EL that represents each of the evaluation directions is set. Each of the evaluation specific areas ESA is obtained in such a manner that the initial evaluation specific area ESA(0) is rotated at the same angle as the rotation angle from the reference line RL to each of the evaluation direction lines EL (see FIG. 15). However, each of the evaluation specific areas ESA need not be set as the area described above. For example, the evaluation specific area ESA corresponding to each of the evaluation direction lines EL all may be set as the same area as the initial evaluation specific area ESA(0). In this case as well, it is only necessary to calculate the average of R values as the evaluation value with respect to the target pixel specifying line PL perpendicular to each of the evaluation direction lines EL. In the above case as well, when the evaluation direction in which the variance of evaluation values is maximum is selected, it is possible to achieve adjustment of inclination of the face area FA, which is suitable for the inclination of an image.

### B5. Fifth Alternative Embodiment

In the above example embodiment, when the position or inclination of the face area FA is adjusted, the position or inclination of the images of eyes, which serve as a reference subject, are detected, and the position or inclination of the face area FA is executed using the detected position or inclination. However, another image, such as the image of a nose or the image of a mouth, for example, may be used as a reference subject.

In addition, the detection of position or inclination of the image of a reference subject in the present example embodiment is not limited to the case in which the position or inclination of the face area FA is intended to be adjusted, but it may be widely applicable to the case in which the position or inclination of the image of a reference subject in the target image TI is detected. In this case, the reference subject is not limited to the portion of a face, but a selected subject may be used as a reference subject.

### B6. Sixth Alternative Embodiment

In the above example embodiment, the deformation area TA (see FIG. 18) is set as a rectangular area; however, the deformation area TA may be set as an area having another shape, such as an elliptical shape or a rhombic shape, for example.

In addition, the method of dividing the deformation area TA into small areas (see FIG. 19 and FIG. 28) in the above example embodiment is just an example, and another dividing method may be used. For example, the arrangement of the dividing points D in the deformation area TA may be selectively changed. In addition, each of the small areas need not have a rectangular shape but may have a polygonal shape. In addition, the arrangement of the dividing points D in the deformation area TA may be performed in accordance with user's specification.

### B7. Seventh Alternative Embodiment

In the above example embodiment, portion of the deformation area TA may possibly extend outside from the target image TI. In addition, in this case, a portion of the dividing points D cannot possibly be arranged on the target image TI. When a portion of the dividing points D cannot be arranged on the target image TI, the horizontal dividing lines Lh and the vertical dividing lines Lv for defining the positions of those dividing points D may be deleted (see FIG. 19), and dividing of the deformation area TA into small areas may be executed only using the dividing points D that are defined by the remaining horizontal dividing lines Lh and vertical dividing lines Lv. Alternatively, when a portion of the dividing points D cannot be arranged on the target image TI, it is applicable that the face shape correction is not executed.

### B8. Eighth Alternative Embodiment

In the above example embodiment, the content of the face shape correction printing process (FIG. 3) is just an example, and the order of the steps may be changed or a portion of the steps may be not executed or omitted. For example, before the face shape correction (step S100 in FIG. 3), resolution conversion or color conversion in the printing process (step S210 or step S220 in FIG. 26) may be executed.

In addition, the order of the adjustment of position of the face area FA (step S140 in FIG. 4) and the order of the adjustment of inclination of the face area FA (step S150 in FIG. 4) may be interchanged. In addition, it is also applicable that one of these processes is executed and the other process is omitted. In addition, it is also applicable that, immediately after the face area FA has been detected (step S130 in FIG. 4), setting of the deformation area TA (step S160 in FIG. 4) is executed, and the same adjustment of position or the same adjustment of inclination is performed on the set deformation area TA. In this case as well, because the deformation area TA is an area that at least includes portion of a face image, it may be regarded that the adjustment of position or the adjustment of inclination of the area that includes the face image is performed.

In addition, in the above example embodiment, the detection of the face area FA (step S130 in FIG. 4) is executed; however, in place of the detection of the face area FA, for example, information of the face area FA may be acquired through user's specification.

### B9. Ninth Alternative Embodiment

In the above example embodiment, the face shape correction printing process (FIG. 3) by the printer 100, which serves as an image processing device, is described; however, the face shape correction printing process may be performed in such manner that, for example, the face shape correction (step S100 in FIG. 3) is executed by a personal computer and only the printing process (step S200) is executed by the printer. In addition, the printer 100 is not limited to an ink jet printer, but it may include printers of other types, such as a laser printer or a dye sublimation printer, for example.

### B10. Tenth Alternative Embodiment

In the above example embodiment, a portion of configuration implemented by hardware may be replaced by software, or, conversely, a portion of configuration implement by software may be replaced by hardware.

What is claimed is:

1. An image processing device that performs deformation of an image, comprising:
a deformation area setting unit that sets at least a portion of an area on the image as a deformation area;
a deformation area dividing unit that divides the deformation area into a plurality of divided areas; and
a deformation processing unit that performs deformation of the image within the deformation area by deforming the divided areas, wherein
the deformation processing unit performs deformation of the image in a manner that, with respect to an area having a N-polygonal shape among the plurality of divided areas, N triangles that are defined by line segments, each of which connects the centroid of the divided areas, which have not yet been deformed, with each vertex of the same divided areas, are deformed into N triangles that are defined by line segments, each of which connects the centroid of the divided areas, which have been deformed, with each vertex of the same areas.

2. The image processing device according to claim 1, wherein the deformation area setting unit sets the deformation area so that the deformation area includes at least a portion of the image of a face.

3. The image processing device according to claim 2, further comprising:
a face area detection unit that detects a face area in which the image of the face appears on the image, wherein
the deformation area setting unit sets the deformation area on the basis of the detected face area.

4. The image processing device according to claim 1, further comprising:
a printing unit that prints out the image on which deformation of an image in the deformation area has been performed.

5. An image processing method for performing deformation of an image, comprising:
setting at least a portion of an area on the image as a deformation area;
dividing the deformation area into a plurality of divided areas; and
performing deformation of the image within the deformation area by deforming the divided areas, wherein
when the deformation of the image within the deformation area is performed, the deformation of the image is performed in a manner that, with respect to an area having a N-polygonal shape among the plurality of divided areas, N triangles that are defined by line segments, each of which connects the centroid of the divided areas, which have not yet been deformed, with each vertex of the same divided areas, are deformed into N triangles that are defined by line segments, each of which connects the centroid of the divided areas, which have been deformed, with each vertex of the same areas.

6. A computer program executable on a computer for image processing for performing deformation of an image, comprising instructions for:
setting at least a portion of an area on the image as a deformation area;
dividing the deformation area into a plurality of divided areas; and
performing deformation of the image within the deformation area by deforming the divided areas, wherein
when the deformation of the image within the deformation area is performed, the deformation is performed in a manner that, with respect to an area having a N-polygonal shape among the plurality of divided areas, N triangles that are defined by line segments, each of which connects the centroid of the divided areas, which have not yet been deformed, with each vertex of the same divided areas, are deformed into N triangles that are defined by line segments, each of which connects the centroid of the divided areas, which have been deformed, with each vertex of the same small areas.

7. The image processing device according to claim 1, wherein the deformation area is a shape selected from a group comprising rectangle, ellipse, and rhomboid.

8. The image processing device according to claim 1, wherein the small areas have a shape selected from a group comprising rectangle and polygonal.

9. The image processing device according to claim 1, wherein said small areas include images of eyes, and said small areas that include images of eyes are not deformed.

10. The image processing device according to claim 1, further including a user interface, wherein the deformation area dividing unit uses dividing points to divide the deformation area, and the deformation processing unit moves the dividing points in accordance with a moving mode that is specified through the user interface.

11. The image processing device according to claim 10, wherein the dividing points are arranged are arranged in the deformation area, and the arranged dividing points are moved.

12. The image processing device according to claim 10, wherein the dividing points are moved in accordance with a moving direction and an amount of movement that is associated with a combination of a selected deformation type and a deformation degree.

13. The image processing device according to claim 1, further including a specific area setting unit that sets a specific area, wherein the specific area includes images of eyes, the specific area is divided into a left side area and a right side area by a reference line, and detection of a position of the eye is performed separately on the left side area and the right side area.

14. The image processing device according to claim 1, wherein the deformation area extends outside of the target image.
